(19) United States
(12) Patent Application Publication
(10) Pub. No.: US 2015/0309645 A1
(43) Pub. Date: Oct. 29, 2015

(54) SYSTEM AND METHOD FOR PROVIDING INFORMATION IN PHASES

(71) Applicant: Si-Han KIM, (US)

(72) Inventor: Si-Han KIM, Gwangju (KR)

(21) Appl. No.: 14/386,600

(22) PCT Filed: Mar. 21, 2013
(86) PCT No.: PCT/KR2013/002350

§ 371 Date: Jan. 28, 2015

(30) Foreign Application Priority Data
Mar. 21, 2012 (KR) 10-2012-0028609

(51) Int. Cl. G06F 3/041; G09G 5/00

(52) U.S. Cl. CPC G06F 3/0416; G09G 5/003; G09G 2370/022

(57) ABSTRACT

The present invention relates to a terminal comprising a display, a central processing device, and an input device. When a phase operating command for distinguishing phases is inputted on the display, the input device outputs the phase operating command, and the central processing device recognizes the phase of the phase operating command and outputs information which matches the recognized phase to the display. Thus, information which is associated with information displayed on the current screen can be effectively displayed on a display screen even without executing several screen changing commands.

### TECHNICAL FIELD

The present invention generally relates to the provision of information in phases and, more particularly, to a system that executes manipulation commands in respective phases on a display via various types of input devices and provides the contents of information in phases in compliance with the phase manipulation commands.

### BACKGROUND ART

A touch screen or touch panel denotes a user interface device which allows a user to directly touch a specific character or point on a screen with his or her finger or any manipulation means without using a keyboard, detects the touched point, and processes a certain operation on the touched point using prestored software. As an example, touch panels include a resistive overlay type, a surface acoustic wave type, a capacitive overlay type, an infrared beam type, etc.

Further, owing to touch input devices based on various types as described above, a desired manipulation command may be directly executed on a display, and such a touch input device is actually being used as an input unit in personal portable terminals (a smart phone, a Personal Digital Assistant (PDA), an MP3 player, a mobile phone, etc.), tablet Personal Computers (PCs), etc.

However, on the display of a current terminal, a large number of pieces of information are mutually associated, so that a detailed method for effectively displaying information associated with other information currently displayed on the display is not yet presented. That is, at the present time, information currently displayed on a screen is linked only by clicking. When there are one or more phases of information currently displayed on the screen, such phases are not effectively linked at the present time.

That is, as disclosed in U.S. Pat. No. 6,639,584, patent technology related to a method of inputting control commands while moving on a display screen is presented. However, a detailed method for inputting a control command on the display and controlling a detail degree in which information is displayed or controlling the amount of information displayed on the display is not currently presented.

Further, another conventional technology in U.S. Pat. No. 7,657,849 merely provides a method of assigning a lock function via an input device on a display.

Therefore, there is urgently required a method of, when content is used, providing information in phases and promptly displaying desired information on a screen. (Prior art Document 1) U.S. Pat. No. 6,639,584 (Date of Publication: Oct. 28, 2003)

(Prior art Document 2) U.S. Pat. No. 7,657,849 (Date of Publication: Feb. 2, 2010)

### DISCLOSURE

### Technical Problem

Accordingly, the present invention has been made keeping in mind the above problems, and an object of the present invention is to provide a system and method, which display or provide the contents of information in phases in compliance with a phase manipulation command that is input via an input device on a display, or which link information present in a separate storage location.

### Technical Solution

The above object is achieved by a configuration in which a terminal provided with a display, a Central Processing Unit (CPU), and an input device is configured such that, when a phase manipulation command for distinguishing individual phases is input on the display, the input device outputs the phase manipulation command, and the CPU recognizes a phase of the phase manipulation command and outputs information suitable for the phase to the display.

Further, the CPU may be configured to, when a point on the display is selected, and the point is moved and then information about a movement distance of the point is output, determine the movement distance to be a phase, and may be configured to, when a point on the display is selected, and the point is rotated and then information about a rotational direction of the point is output, determine an angle of a rotational motion of the point to be a phase.

Furthermore, the phase may include a positive (+) movement phase and a negative (−) movement phase, and may be designated, as two points are selected via the input device and a distance between the two points is shortened or lengthened.

As another embodiment of the present invention, a terminal provided with a display, a Central Processing Unit (CPU), and an input device is connected to a server provided with a database (DB) and a control unit, when a phase manipulation command for distinguishing individual phases is input on the display, the input device outputs the phase manipulation command, and the CPU recognizes a phase of the phase manipulation command, the CPU transmits information about determination of the phase of the phase manipulation command to the server, or transmits a phased manipulation command signal from the input device to the server, and the server outputs information about the phase from the DB and transmits the information to the terminal.

Further, the CPU may be configured to, when a point on the display is selected, and the point is moved and then information about a movement distance of the point is output, determine the movement distance to be a phase, and may be configured to, when a point on the display is selected, and the point is rotated and then information about a rotational direction of the point is output, determine an angle of a rotational motion of the point to be a phase.

Furthermore, the phase may include a positive (+) movement phase and a negative (−) movement phase.

In addition, the phase may be designated, as two points are selected via the input device and a distance between the two points is shortened or lengthened.

Furthermore, when a current phase is phase N and is moved in a positive (+) direction by J phases, a finally selected phase may be phase N+J. Furthermore, when a current phase is phase N and is moved in a negative (−) direction by I phases, a finally selected phase may be phase N−I.

### Advantageous Effects

According to the present invention, when a phase manipulation command is executed with a finger or a manipulation means via an input device on a display, information may be provided in phases. In addition, when multi-phase information is provided, it may be displayed on the same screen without changing the screen, and a link to information stored in another Internet website or another storage location may be performed.

### DESCRIPTION OF DRAWINGS

FIG. 1 is a diagram showing the configuration of a terminal connected to a server over the wired/wireless Internet;

FIG. 2 is a block diagram showing in greater detail the server;

FIG. 3 is a block diagram showing the terminal;

FIG. 4 is a diagram showing in brief a typical input device and an input device driving unit;

FIG. 5 is a diagram showing an embodiment in which a phase manipulation command is executed via an input device;

FIG. 6 is a diagram showing an embodiment in which phase manipulation commands are described;

FIG. 7 is a diagram showing another embodiment in which a manipulation command is executed via an input device;

FIGS. 8 and 9 are diagrams showing the phases of the manipulation command in the embodiment of FIG. 7;

FIG. 10 is a diagram showing an embodiment in which display information on the entire screen is changed in compliance with a phase manipulation command;

FIG. 11 is a diagram showing an embodiment in which partial display information on the screen is changed in compliance with a phase manipulation command;

FIGS. 12 to 14 are flowcharts showing the processing sequence of the present invention;

FIG. 15 is a diagram showing a further embodiment in which a phase manipulation command is executed;

FIG. 16 is a flowchart showing the execution of manipulation commands based on guidelines;

FIG. 17 is a diagram showing another embodiment of a phased input method;

FIGS. 18 to 23 are diagrams showing embodiments in which the size of a selection area is changed according to the phase;

FIGS. 24 and 25 are diagrams showing embodiments in which the content and size of information are variably changed;

FIGS. 26 to 28 are diagrams showing other embodiments of the case where a selection area is present on the entire screen;

FIG. 29 is a diagram showing another embodiment of the present invention;

FIG. 30 is a diagram showing an embodiment in which a selection area enabling phase manipulation commands to be executed may be designated;

FIG. 31 is a diagram showing an embodiment of a method of storing information in phases;

FIG. 32 is a diagram showing an embodiment in which an image magnification function and a phase manipulation command function are distinguished from each other;

FIG. 33 is a diagram showing an embodiment in which a phase manipulation command is executable according to a selected time;

FIG. 34 is a diagram showing an embodiment in which a new function may be assigned to a phase manipulation command;

FIG. 35 is a diagram showing an embodiment of a method in which a guideline is displayed;

FIG. 36 is a diagram showing an embodiment in which a phase may be added;

FIGS. 37 to 40 are diagrams showing embodiments in which a selection area is present in a text message service; and

FIGS. 41 and 42 are diagrams showing embodiments of the case in which two or more displays are provided.

### BEST MODE

Hereinafter, embodiments of the present invention will be described in detail with reference to the attached drawings. The configurations of the present invention and the operations and effects thereof will be clearly understood from the following detailed descriptions.

Further, detailed descriptions of well-known technical components may be omitted.

In the present invention, information is displayed on a display screen via a “phase manipulation command”. That is, phase 1, phase 2, phase 3, and phase N are present, manipulation commands are executed in phases via an input device, and pieces of information corresponding to respective phases are displayed on the display screen.

Further, a “selection area” enabling a phase manipulation command to be executed only in a partial area of the entire display screen may be present.

### Embodiment 1

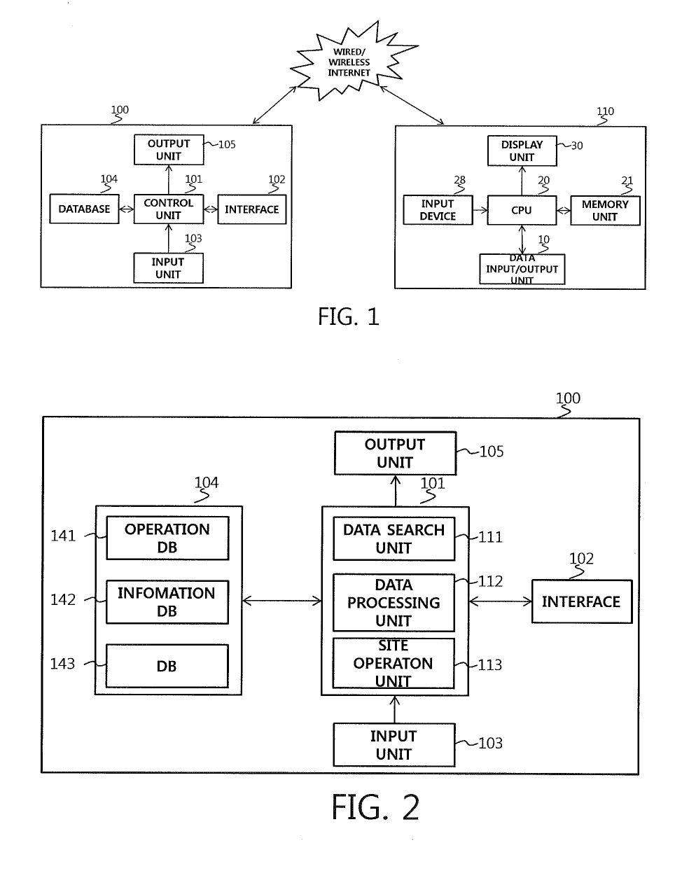

FIG. 1 is a diagram showing the configuration of a terminal connected to a server over the wired/wireless Internet.

A server 100 in a communication system is a device configuring a system that operates various types of information provision services over the wired/wireless Internet. The server is provided with an input unit 103 allowing the manager or operator of the server 100 to input and manage information, an output unit 105 for outputting or displaying information (including a connection port, a printer, or the like for outputting information), a database (DB) unit 104 for storing various types of information and information related to the operation of services, and an interface unit 102 capable of transmitting or receiving data to or from an accessing user over the Internet or a communication network. Meanwhile, information denotes all types of information including an image, a video, text, etc.

Further, a terminal (or computer) 110 is a terminal capable of transmitting or receiving various types of information over the wired/wireless Internet (or communication network).

Therefore, the terminal 110 includes a Central Processing Unit (CPU) 20, a display unit 30 for displaying various types of information, a memory unit 21 for storing various types of information, an input device 28 for inputting information, and a data input/output unit 10 for inputting/outputting information or data.

FIG. 2 is a block diagram showing in greater detail the server.

In the server 100, a control unit 101 is configured and includes a data search unit 111 for searching for data, a data processing unit 112, and a site operation unit 113 for managing and operating Internet-accessing users or Internet members.

Furthermore, a database (DB) 104 is further configured, and includes an operation DB 141 for storing information related to the operation of sites, an information DB 142 for storing pieces of data suitable for respective pieces of information, and a DB 143 for storing a plurality of pieces of information.

Furthermore, the control unit 101 and the DB 104 are merely examples, and it may be considered that any typical control unit for performing all algorithms for server operation and any typical DB for storing all types of information are included in the embodiment of the present invention.

Meanwhile, in the control unit 101 of the server 100, the site operation unit 113 determines the information of an accessing user (or terminal), information about whether the accessing user is a member, and information related to the use of content. The data search unit 111 searches the DB 14 for information matching the information transmitted from an accessing user (or a terminal), and the data processing unit 112 transmits the results of executing an algorithm or the like and data found from a search to the accessing user through an interface.

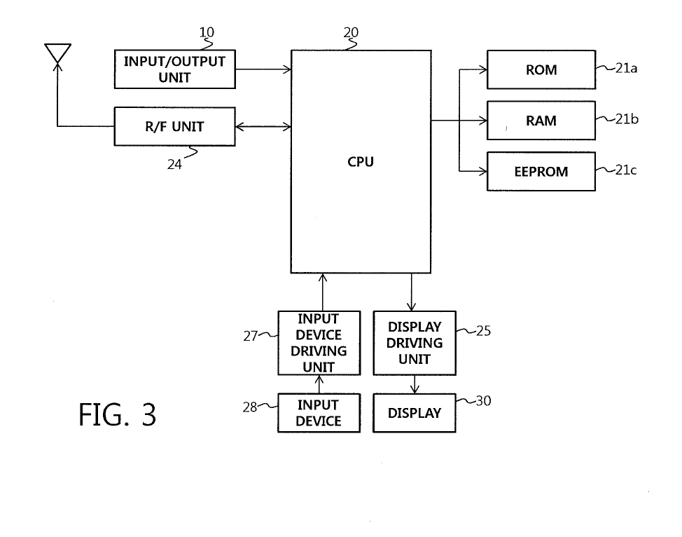

FIG. 3 is a block diagram showing the terminal.

In the drawing, a CPU 20 is a control means for controlling the entire operation of a terminal (generally, a portable display device, a smart phone, or a computer) used in the embodiment of the present invention. Further, Read Only Memory (ROM) 21a present in a memory unit 21 (or 21a, 21b, or 21c) controls programs to be executed on the display device; Random Access Memory (RAM) 21b stores data generated during the execution of each program; and electrically erasable programmable ROM (EEPROM) 21c stores data required by a user and required to process such data.

A Radio Frequency (R/F) unit 24, which is operated in an RF band, is tuned to an RF channel and is configured to amplify various types of input signals, and convert the RF signals received through an antenna into required frequency signals. The input/output unit 10 includes an input unit and an output unit, wherein the input unit includes various types of information input devices, numeric keys, menu keys, and selection keys, and the output unit includes a speaker, a vibrating device, etc.

A display driving circuit 25 for receiving signals output from the CPU 20 and displaying the display is provided. The driving circuit outputs a signal required to drive the display 30.

Further, the CPU controls an input device 28 through an input device driving unit 27. That is, when information is input via the input device 28, the input device driving unit transmits the input information to the CPU.

Meanwhile, the terminal of the present invention may include a portable display device, a smart phone, a tablet PC, or a typical PC.

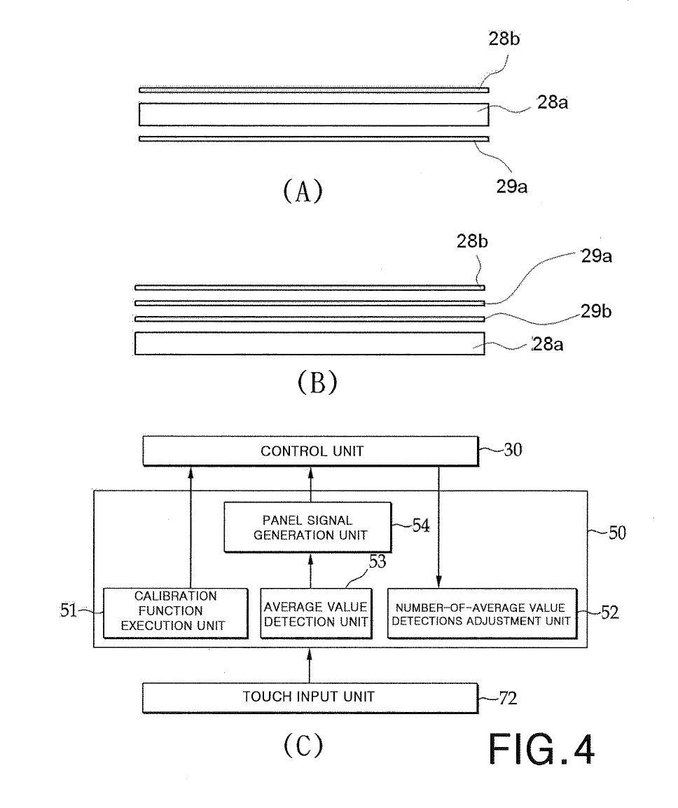

FIG. 4 is a diagram showing in brief a typical input device and an input device driving unit.

The drawings are sectional views showing the input device in brief, wherein (A) is a view showing a capacitive type and (B) is a view showing a resistive type.

That is, in (A), an electrode plate 29a coated with a transparent electrode is disposed beneath a protective plate 28a, and the electrode plate 29a is composed of one or two films, each coated with a transparent electrode.

Further, in (B), two films 29a and 29b, each coated with a transparent electrode, are provided on the top of a protective plate 28a so that they are opposite each other while being spaced apart from each other by a predetermined distance. An external protective plate (or a veneering plate) 28b may be further provided on the top of the input device 28. Furthermore, a coating having a desired pattern is applied to the protective plate 28b.

FIG. 4 illustrates an example of the input device 28 that is typically and widely used, and the present invention does not relate to the input device 28. Therefore, any typical input device 28 enabling information to be input on the display may be applied to the present invention.

Here, the term “on the display” means that information may be input without a pressure or contact being applied to the surface of the display.

Further, the embodiment of the present invention may be applied to devices in which an input device and a display are integrated with each other.

Meanwhile, as long as individual phases may be distinguished from each other via variation in image or action and information may be input, such an image or action variation may be applied to the embodiment of the preset invention.

The diagram in (C) illustrates an embodiment of the input device driving unit. The diagram in (C) merely illustrates a single embodiment, and the present invention may use any type of typical input device driving unit.

A touch input driving unit 50 according to an embodiment of the present invention includes a calibration function execution unit 51, a number-of-average value detections adjustment unit 52, an average value detection unit 43, and a panel signal generation unit 54.

Further, it may be considered that the input device driving unit of the present invention is only an embodiment and a typical input device driving unit is included in the configuration of the present invention.

The calibration function execution unit 51 calibrates the coordinate values of a touch input unit 72 when the device is initially operated. By means of this calibration function, panel signals corresponding to the coordinate values of an actual point touched on the touch input unit 72 are selected. That is, the signal of the touch input unit 72 corresponding to coordinate values is selected depending on the resolution of a touch display 74, and the selected signal is provided to a control unit 30.

Accordingly, the control unit 30 stores and manages coordinate values corresponding to panel signals. The number-of-average value detections adjustment unit 52 adjusts the number of detections of average values of the panel signals output from the touch input unit 72, based on the screen resolution information of the touch display 74 which is provided from the control unit 30. When the screen resolution is changed to high resolution, the number of average value detections is adjusted to a value greater than a previously set value. In contrast, when the screen resolution is changed to low resolution, the number of average value detections is adjusted to a value less than a previously set value.

The average value detection unit 53 detects the average value of the panel signals transmitted from the touch input unit 72, based on the number of average value detections adjusted by the number-of-average value detections adjustment unit 52. Further, the average value detection unit 53 transmits the detected average value to the panel signal generation unit 54.

The panel signal generation unit 54 generates panel signals using the changed screen resolution of the touch display 74 provided from the control unit 30 or the location information of the display screen changed by a virtual scroll, and the average value of currently input panel signals.

The touch input driving unit 50 configured in this way is configured to, when the user touches a certain point with one or two fingers or with any manipulation means, successively detect the location information of the touched point a predetermined number of times, and then output the average value of the detected values as final location information.

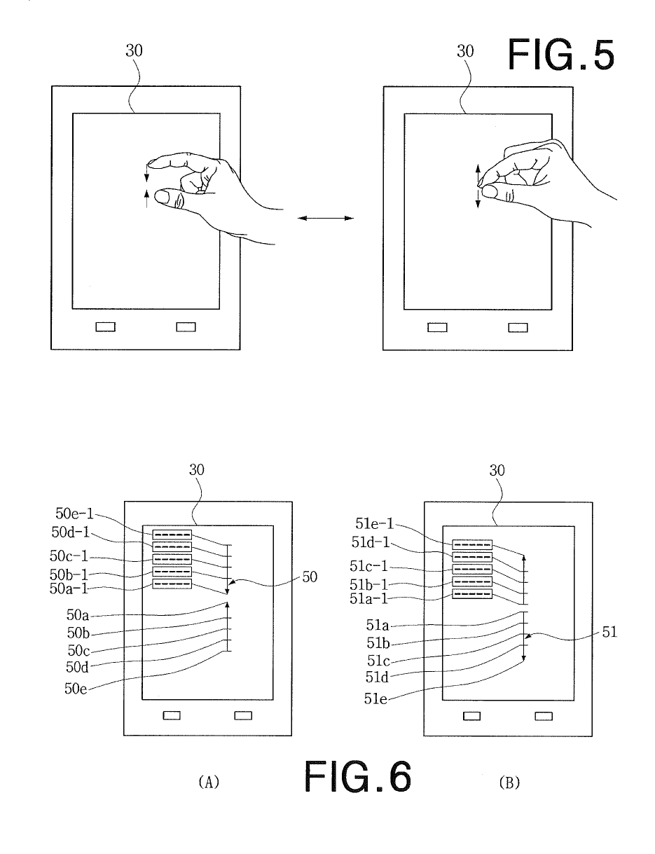

FIG. 5 is a diagram showing an embodiment in which phase manipulation commands are executed via an input device.

As shown in the embodiment of FIG. 5, individual phase manipulation commands are issued using small bars or using fingers on a display 30.

That is, each phase manipulation command is input by selecting information displayed on the display via the input device 28. As shown in FIG. 5, the corresponding phase manipulation command is executed using a method of exploiting two fingers (or bars) and of shortening or lengthening a distance between two points selected by the two fingers (or bars).

FIG. 6 is a diagram showing an embodiment in which phase manipulation commands are described.

Two points are designated using two fingers (or two bars) and movement distances between the two points are divided into phases, and manipulation commands enabling commands to be recognized depending on respective phases are “phase manipulation commands”. Further, when each phase manipulation command is executed, information corresponding to each phase is displayed on the screen of the terminal display 30. The phase is a limited number N corresponding to the number of at least two phases. Since an excessively large number of phases do not result in a desirable influence, less than 10 phases or 5 phases are appropriate.

Further, phases are summarized as follows.

1) Phases are designated as phase 1, phase 2, phase 3, and phase N, and a distance identified as a single phase is designated in advance.

2) The maximum number of identifiable phases is preset. The maximum identifiable distance is also preset.

3) Each phase manipulation command has a positive (+) direction and a negative (−) direction.

4) When the phase manipulation command is executed, an error range is present.

5) For respective phases, pieces of information corresponding to the phases are present.

Referring to FIG. 6, guidelines 50 and 51, which are movement paths between two points, are indicated. As shown in the diagram (A), respective phases 50a, 50b, 50c, 50d, and 50e are indicated on the guide lines (in the diagram (B), respective phases are “51a, 51b, 51c, 51d, and 51e”).

In case of the diagram (A) in which the distance between the selected two points is shortened, phase 1 is “50a”, phase 2 is “50b”, phase 3 is “50c”, phase 4 is “50d”, and phase 5 is “50e”.

In case of the diagram (B) in which the distance between the selected two points is lengthened, phase 1 is “51a”, phase 2 is “51b”, phase 3 is “51c”, phase 4 is “51d”, and phase 5 is “51e”.

Further, when a distance at which the points are moved by one phase is set to 10 mm, two-phase movement is made if the points are moved 20 mm in compliance with a phase manipulation command. Since the total number of phases is five, the maximal movement distance is 50 mm.

Of course, there is no need to set the distance for each phase to the same distance value. For example, it is possible that the distance from phases 1 to 2 is set to 10 mm and the distance from phases 2 to 3 is set to 12 mm. The distance for each phase is merely preset.

Further, the distance for each phase may be variously set when an algorithm is designated to execute a program. For example, although the movement distance from phase 1 to phase 2 is 10 mm, the movement distance between the phases may be manually or automatically changed to 12 mm before a phase manipulation command is executed.

Further, when two points selected by the input device become closer to each other, a minus (negative, −) movement is made, whereas when the two points become far away from each other, a positive (plus, +) movement is made (on the contrary, this function may be designated such that, when two points become closer to each other, a positive (+) movement is made, whereas when the two points become far way from each other, a negative (−) movement is made).

Therefore, in the example of FIG. 6(A), when one-phase movement is set to 10 mm and movement is made by 20 mm, it can be seen that the points are moved in the negative (−) direction by two phases. Further, in the example of FIG. 6(B), when one-phase movement is set to 10 mm, and movement is made by 20 mm, it can be seen that the points are moved in the positive (+) direction by two phases.

Meanwhile, as in the case of the item in 4), it is apparent that an error range may be present in each phase manipulation of the present invention. In other words, when the points are moved 13 mm, one-phase movement may be determined to be performed, and when the points are moved 18 mm, two-phase movement may be determined to be performed. Such an error range corresponding to the execution of phase manipulation commands may be designated according to the concept of rounding-up and rounding-down in mathematics.

Further, in the present invention, when it is desired to execute a phase manipulation command, guidelines 50 and 51, on which scales for respective phases are indicated, may be displayed on the screen of the display 30, as shown in the embodiment of FIG. 6.

In the present invention, “guidelines 50 and 52” correspond to a method by which each phase and a distance and direction corresponding to each phase are displayed on the display screen, and then each phase manipulation command may be conveniently executed. Of course, the guidelines 50 and 52 are not necessarily displayed on the screen.

Since such guidelines are displayed, information corresponding to the movement distance in each phase may be visually provided. That is, the points are moved a distance corresponding to the scales indicated on the guidelines 51 and 52, thus enabling a manipulation command in a desired phase to be executed.

In FIG. 6, pieces of information corresponding to respective phases are “(50a-1), (50b-1), (50c-1), (50d-1), and (50e-1)” and “(51a-1), (51b-1), (51c-1), (51d-1), and (51e-1)”.

That is, in (A), information corresponding to phase 1 “50a” is “50a-1”, and in (B), information corresponding to phase 1 “51a” is “51a-1”.

Meanwhile, the user of the present invention needs to make a selection so that the guidelines are displayed on the screen of the display. That is, when a selection is made according to a designated method, the guidelines may be displayed and then the corresponding phase manipulation command may be executed.

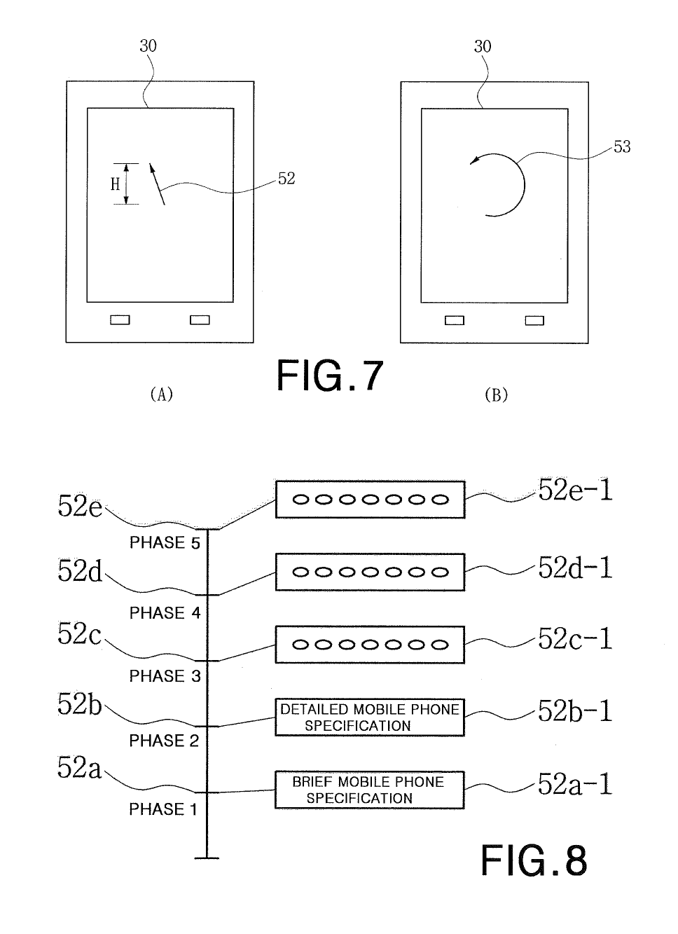

FIG. 7 is a diagram showing another embodiment in which a manipulation command is executed via the input device.

FIG. 7(A) is a diagram showing an embodiment in which one point selected by a finger or bar via the input device is moved, and (B) is a diagram showing an embodiment in which rotational motion is performed and a moved angle is indicated. Further, a command in a positive (+) phase may be set to a command in which the point is moved upwards or is rotated counterclockwise, and a command in a negative (−) direction may be set to the command opposite that of the positive (+) direction.

Meanwhile, as a further embodiment of the present invention, movement directions may be designated to be subdivided into detailed directions from upward and downward directions. A vertical (upward/downward) direction/ and a horizontal (leftward/rightward) direction are designated, and then individual phases may be designated. That is, the phases may be designated in such a way that an upward movement is phase 1, a rightward movement is phase 2, and a downward movement is phase 3. Further, such directions may be subdivided into several directions. That is, the entire direction is divided into 9 phases by 40° in a clockwise direction. For example, when the point is moved clockwise at an angle of 80° , phase 2 is executed.

Such movement is performed such that a movement range is divided into phases in the directions defined by angles with respect to a selection area or with respect to one point.

### Embodiment 2

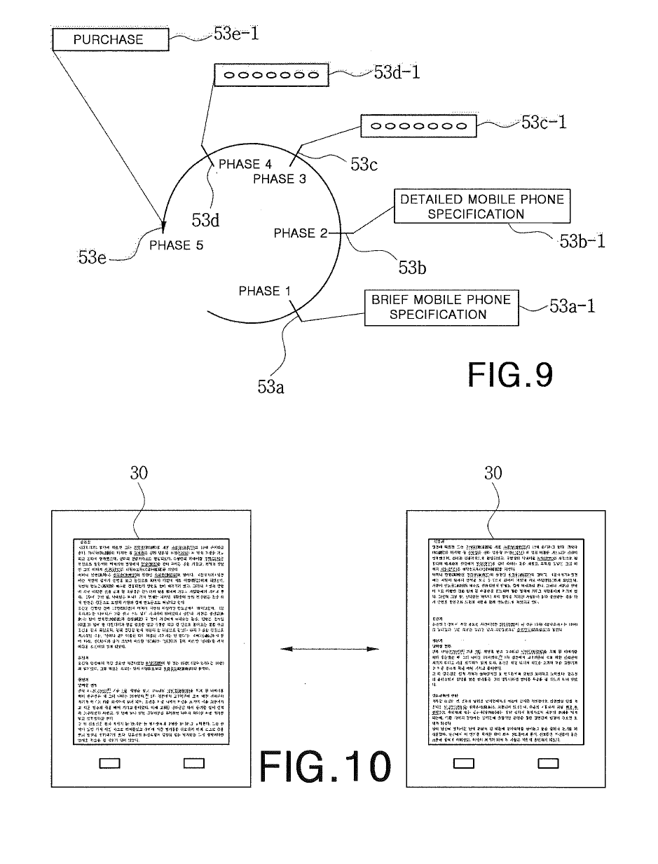

FIGS. 8 and 9 are diagrams showing the phases of manipulation commands in the embodiment of FIG. 7.

FIG. 8 illustrates the embodiment of FIG. 7(A). The drawing shows that a movement distance (upward movement is + movement, and downward movement is − movement) is divided into phases, and the feature of information in each phase (information contents) may be displayed on the screen. For example, phase 1 is “52a”, and phase 2 is “52b”. Further, phase 1 summary information is “52a-1”, and phase 2 summary information is “52b-1”. Therefore, on the screen of the display 30, numerals indicating respective phases and pieces of summary information corresponding to the respective phases may be displayed.

In the embodiment of FIG. 8, numbers indicating phases are indicated on a guideline, and pieces of summary information corresponding to respective phases are displayed. For example, summary information corresponding to phase 1 52a is “brief mobile phone specification”, and summary information corresponding to phase 2 52b is “detailed mobile phone specification”. Therefore, when phase 2 is selected, information for the detailed mobile phone specification is displayed on the screen of the display.

Data about the design of each guideline and summary information displayed on the guideline according to the embodiment of FIG. 8 may be stored in the memory unit 21 of the terminal 110 and also be stored in the DB 104 of the server 110.

Further, when a phase manipulation command is selected (user's selection), the CPU 20 of the terminal displays the guideline display information stored in the memory unit 21 on the display in response to the selection signal.

Meanwhile, when a selection signal for the phase manipulation command is transmitted to the server under the control of the CPU 20, the control unit of the server searches the DB for guideline display information stored therein and transmits the found information to the terminal. Then, the terminal displays the received information on the screen of the display.

Further, FIG. 9 illustrates the embodiment of FIG. 7(B). That is, the drawing shows that the moved angle may be divided into phases, and respective phases and information features for respective phases (summary information) may be displayed on the screen.

Meanwhile, a process for performing the embodiments of FIGS. 5 to 9 an execution procedure will be described below.

1) When a point is selected (using a finger or bar) via the input device 28 of the terminal, the input device driving unit 27 outputs the location information (coordinates) of the selected point. When the point is moved, the input device driving unit 27 outputs the movement information (coordinates) of the point.

2) The CPU 20 determines the displayed point location and the movement information of the point, determines a movement phase using a designated algorithm, and determines a selected final phase.

For example, when the current phase is phase 2, and the point is moved in the positive (+) direction by two phases, the selected final phase is phase 4.

3) When the selected final phase is designated, the CPU 20 selects information corresponding to the final phase from the memory unit 21 (or 21a, 21b, or 21c), and outputs a drive signal enabling the selected information to be displayed on the display 30.

In this case, the final phase is transmitted to the server, and the control unit of the server may search the DB for information corresponding to the final phase and transmit the found information to the terminal. Then, the terminal displays the information corresponding to the final phase, received from the server, on the screen of the display.

Further, a specific area may be selected or a point may be designated and selected, and the length of a time during which the area or point is maintained may be divided into phases.

Furthermore, a degree at which the terminal itself is shifted or moved may also be divided into phases.

Meanwhile, motion occurring on the display is recognized by an image device, and a signal output from the image device is determined using an algorithm, so that the degree of motion may be divided into phases. At this time, phases may be divided by the shape of a finger, the shape of an eye, or the shape of another image and then determined.

That is, information corresponding to the final phase after the phase manipulation command has been terminated may be displayed on the screen of the display as long as phases may be classified and divided as phase manipulation commands and may be selected even if any input method is used in the terminal.

### Embodiment 3

FIG. 10 is a diagram showing an embodiment in which the display information on the entire screen is changed in compliance with a phase manipulation command.

This drawing shows that when the phase is changed to phase 1, phase 2, or phase 3, the detail level of displayed information is changed for each phase. That is, the screen on the left side has a detail level higher than that of the screen on the right side.

By using this method, information phases may be classified in such a way that phase 1 is a summary, phase 2 is slightly detailed information, and phase 3 is greater detailed information. Further, in compliance with a phase manipulation command, one of the phases is selected and is displayed on the screen of the display.

For example, when it is desired to display information about King Gwanggaeto, phase 1 is the summary information of King Gwanggaeto, and more detailed information about King Gwanggaeto is displayed as the phase increases. Of course, a method of, as the phase decreases, increasing the detail level of information may also be used.

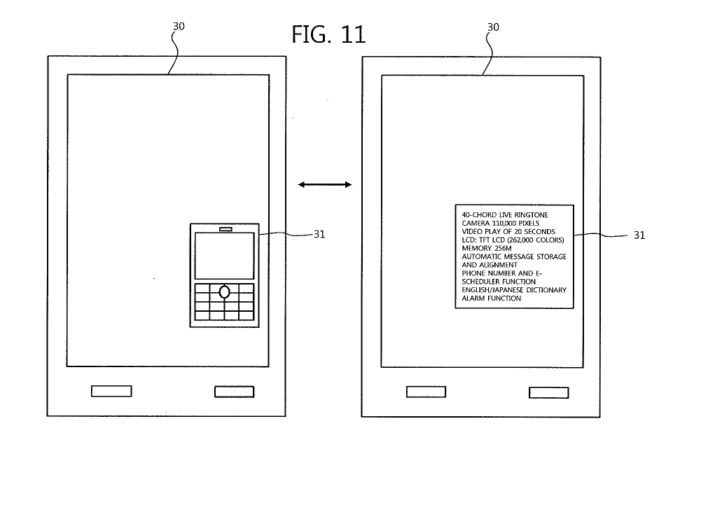

FIG. 11 is a diagram showing an embodiment in which partial display information on a screen is changed in compliance with a phase manipulation command.

A partial area of the entire screen is a selection area 31 in which a phase manipulation command is executed. Therefore, the user of the terminal must select first the selection area. Further, as an example of a selection method, the user selects the selection area 31 on the display for a predetermined period of time. Of course, depending on the types of terminals or programs, various selections may be made. Then, the executability of the phase manipulation command is indicated using an indication method such as the blinking of the selection area 31.

When the user of the present invention selects the selection area 31, the input device outputs information indicating the selection of the selection area 31, and the CPU determines that the selection area 31 has been selected. Of course, output information indicating the selection of the selection area 31 may be transmitted to the server, and then the control unit of the server may determine that the selection area 31 has been selected.

Thereafter, when a given phase manipulation command is executed in the selection area 31, the CPU displays information corresponding to a selected final phase on the screen of the display according to the method in the embodiment of the present invention.

In this case, as the selected final phase is changed, the selection area may be changed as follows.

1) Even if the selected final phase is changed, the size of the selection area may not be changed.

2) When the selected final phase is changed, the size of the selection area may also be changed, wherein, as the phase increases, the size of the selection area may increase in proportion to the increased phase.

3) The size of the selection area may be designated depending on the contents of information to be displayed without increasing the selection area in proportion to the increased phase as the phase increases.

### Embodiment 4

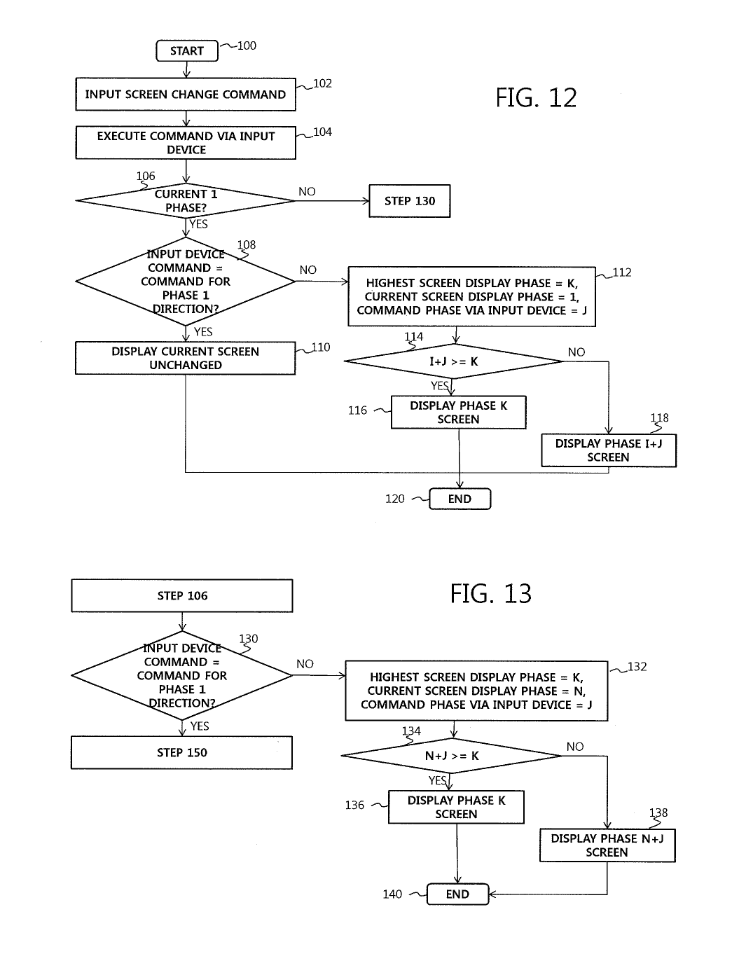

FIGS. 12 to 14 are flowcharts showing embodiments of a process according to the present invention.

The terminal 110 may be connected to the server over the wired/wireless Internet or a communication network and execute a phase manipulation command. That is, when a phase manipulation command is input through the input device 28 of the terminal 110, the input information is transferred to the server over the communication network. The server selects information corresponding to the phase manipulation command from the DB and transmits the selected information to the terminal. The terminal displays received new information on the screen of the display 30.

Further, the information corresponding to the phase manipulation command may be displayed on the screen of the display using the CPU 20 and the memory unit 21 of the terminal.

It is apparent that the execution of an algorithm via connection to the server and on the terminal itself may be designated at each time depending on the type of required program and information. Also, such designation may be implemented based on a program or depending on the selection of the user.

Further, in order to display information corresponding to the phase of the phase manipulation command on the screen of the display, pieces of information corresponding to the respective phases must be classified and stored for respective phases in the DB of the server or the memory unit of the terminal.

For example, when the birth part of King Gwanggaeto is designated as a single unitary content item, information associated with the birth part of King Gwanggaeto is classified into five phases (when the phase is divided into five phases) depending on the detail level and then stored.

That is, pieces of information are stored in such a way that, when content storage information corresponding to “birth part of King Gwanggaeto” is “HiKaKi001”, phase 1 indicating summary information is “HiKaKi001-01”, phase 2 indicating slightly detailed information is “HiKaKi001-02”, and, similarly, phase 5 indicating the most detailed information is “HiKaKi001-5”.

Referring to FIG. 12, a screen change command is input (S102). The term “screen change command” in the present invention denotes a selection command executed before the user executes a phase manipulation command. In compliance with the screen change command, the CPU of the terminal (or the control unit of the server) is prepared to recognize a phase manipulation command.

The screen change command may be issued using a menu button, or may be implemented by selecting the screen (or the selection area) for a predetermined period of time. Of course, depending on the circumstances, the step of issuing a screen change command may be omitted. The CPU (or the control unit) may be prepared to recognize a phase manipulation command merely by displaying information enabling a phase manipulation command to be issued on the display.

First, a phase manipulation command (manipulation command for identifying a phase) is executed via the input device (S104).

Further, it is determined that a current phase is phase 1 (S106). If it is determined that the current phase is not phase 1, the process proceeds to step S130.

Furthermore, it is determined that the movement direction of the phase manipulation command is a positive (+) direction or a negative (−) direction. The phase is moved in a range from 1 to K.

It is determined whether the movement of the phase is movement in a phase 1 direction (movement in the negative (−) direction) (S108).

If it is determined that the movement of the phase manipulation command is movement in a phase 1 direction, the current screen phase is displayed unchanged (S110).

Further, if it is determined that the movement of the phase manipulation command is not movement in a phase 1 direction (movement in a positive (+) direction), the following assumption is made.

When the phase of the phase manipulation command ranges from phase 1 to phase K, the lowest phase is phase 1, and the highest phase is phase K. In this case, a phase input via the input device is assumed to be phase J (S112).

If “1+J>K” is satisfied, the screen corresponding to phase K is displayed, otherwise the screen corresponding to phase “1+J” is displayed (S114 to S118).

FIG. 13 is a flowchart of a process performed when the current screen display phase is not phase 1.

If the direction of the phase manipulation command is phase 1 direction, the process proceeds to “S150”.

Further, if the direction of the command is not the phase 1 direction, the current screen display phase is assumed to be phase N. Of course, the screen display phase is divided into phase 1 to phase K, wherein the lowest phase is 1 and the highest phase is K. In this case, the input phase is assumed to be J phase (S132).

If “N+J>K” is satisfied, the screen corresponding to phase K is displayed, otherwise the screen corresponding to phase “N+J” is displayed (S134-S138). Further, the process may be terminated in compliance with a termination command (S140).

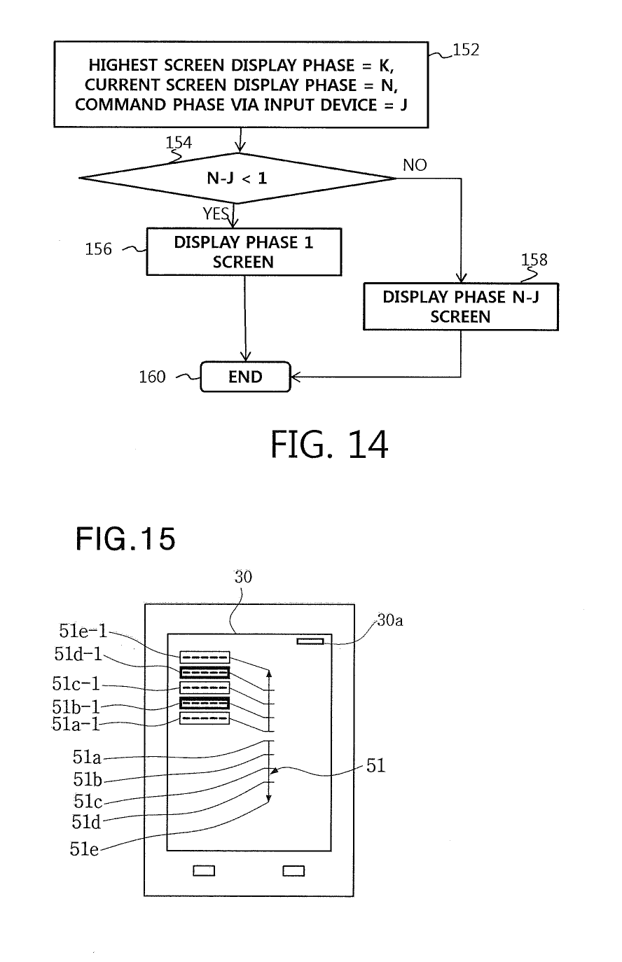

FIG. 14 is a flowchart of a process performed when an input direction is phase 1 direction at step S130 of FIG. 13.

Similarly, the current screen display phase is assumed to be phase N. Of course, the screen display phase is divided into phase 1 to phase K, wherein the lowest phase is phase 1, and the highest phase is phase K. In this case, the phase input via the input device may be assumed to be phase J (S150). If “N−J≦1” is satisfied, the screen corresponding to phase 1 is displayed, otherwise the screen corresponding to phase “N−J” is displayed (S152-S158). Further, the process may be terminated in compliance with a termination command (S160).

Further, the algorithm is executed by the CPU 20 of the terminal or the control unit 101 of the server.

### Embodiment 5

FIG. 15 is a diagram showing a further embodiment in which a phase manipulation command is executed.

When a screen change command 30a is selected (clicking on the screen), and a phase is manipulation command is executed via the input device on the display 30, a manipulation command guideline 51 is displayed on the screen of the display 30. In this case, the screen change command 30a means that the terminal is prepared to recognize the phase manipulation command.

Further, on the manipulation command guideline 51, a current phase is displayed, and a final phase selected by the phase manipulation command is also displayed.

That is, when the current phase is phase 2 and the final phase complying with the phase manipulation command is phase 4, the current phase and the phase subsequent to the phase manipulation command may be displayed using a method of indicating phase 2 and phase 4 by bold lines, as shown in FIG. 15.

Meanwhile, in the embodiment of the present invention, a change in information displayed on the display according to the change in phase is described as follows.

1) As the phase increases, the amount of information displayed on the display increases. The detail level of information also increases.

2) As the phase is changed, the contents of the information displayed on the display are changed (the detail level of information may not increase).

3) As the phase is changed, a program that is executed to display information on the display is changed. For example, as the phase is changed, image information or video information may be displayed. That is, in phase 2, image information may be displayed, and in phase 3, video information may be displayed.

4) As the phase is changed, the layer of information displayed on the display may be changed.

For example, information layers may be changed in such a way that the appearance of a vehicle is displayed in phase 1, the shapes of parts of the vehicle from which the appearance of the vehicle is omitted are displayed in phase 2, and the internal shapes of the parts or the like are displayed in phase 3. That is, information to be displayed on the display may be changed from the appearance to the internal shape of an object depending on the change in phase.

5) As the phase is changed, information stored in a separate storage device or storage location may be displayed on the display.

That is, information stored in a storage place other than the memory unit of the terminal or the DB of the server, which stores pieces of information corresponding to respective phases, may be displayed as the phase is changed.

6) As the phase is changed, a connection to other Internet sites may be made.

That is, in phase 1, phase 2, and phase 3, the stored information is displayed, but a connection to another Internet site may be made in phase 4. Alternatively, a connection to the Internet site may be made in phases 2, 3, and 4. For this, information about a link to an Internet site is stored in the corresponding phase.

7) On the entire screen, a selection area enabling a phase manipulation command to be executed may be separately present. In this case, as the phase increases, the size of the selection area may be further increased, may not be changed, or may be reduced.

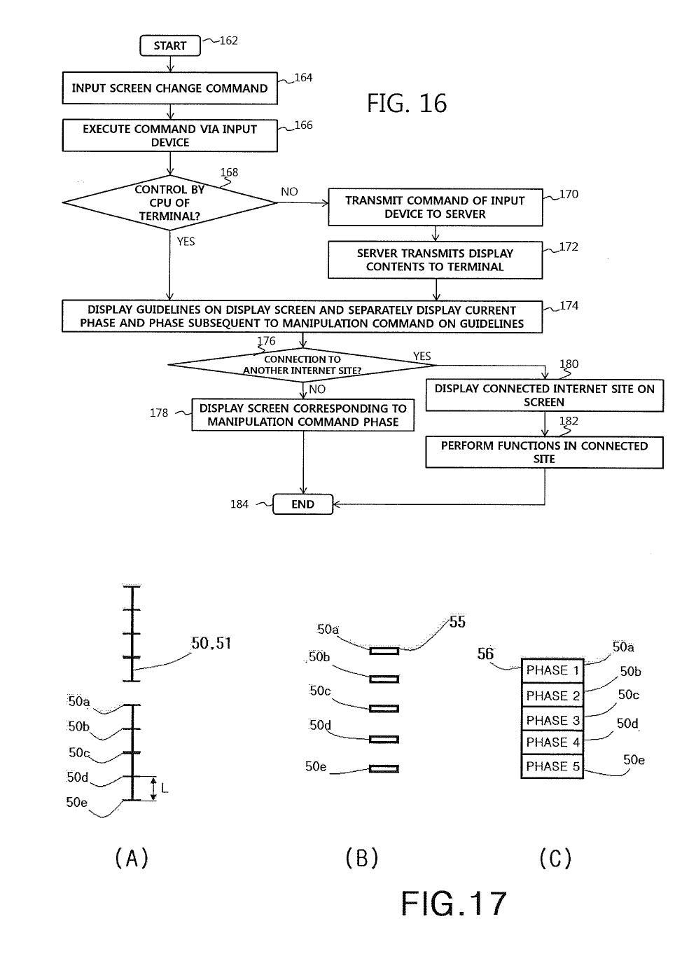

FIG. 16 is a flowchart of a process for executing manipulation commands based on guidelines.

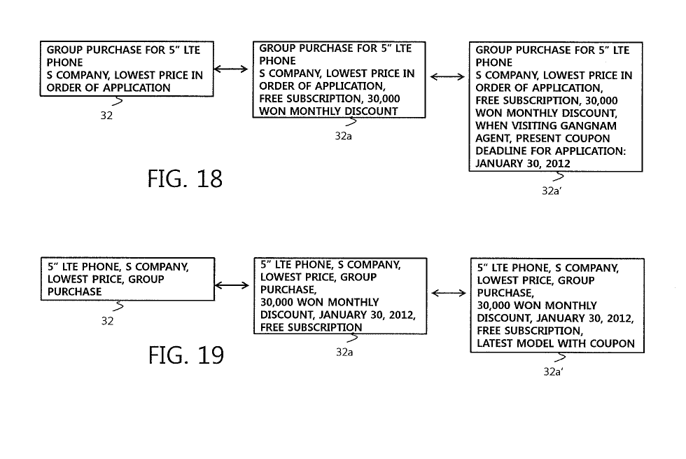

When a manipulation command indicating each phase is executed, guidelines 50 and 51 are displayed on the screen, and scales are indicated on the guidelines 50 and 51, so that the phase manipulation command can be executed while the scales are viewed, thus enabling control commands to be more precisely executed. An embodiment thereof is illustrated in FIG. 18.

After a program has been executed, the user of the terminal inputs a screen change command (S164), and executes a phase manipulation command via the input device (S166).

Further, the screen change command is not limited to the embodiment of the present invention. It is apparent that the screen change command may be executed in compliance with various commands, such as a click action performed for a predetermined period of time, a special movement action, separate menu display on the screen, the pressing of a specific button keyboard or button key, a voice command, or a vibration command.

When the terminal is prepared to recognize a phase manipulation command in compliance with the screen change command, a phase manipulation command is executed via the input device (S166).

If the function of controlling the phase manipulation command is performed on the terminal itself, the CPU of the terminal displays the guidelines 50 and 51, on which phases are indicated, on the screen of the display. Of course, the server may transmit guideline display information to the terminal, and the CPU of the terminal may display the information received from the server on the display.

The design of the guidelines or display information in the guidelines is stored in the memory unit of the terminal or the DB of the server.

Here, a form in which the guidelines are displayed on the screen of the display is not necessarily limited to the shapes of the guidelines 50 and 51 presented in the embodiment of the present invention. Any display form may be applied to the embodiment of the present invention as long as each phase and summary information corresponding to the phase may be displayed.

Meanwhile, if execution is not controlled by the CPU of the terminal and the control unit of the server controls the contents displayed on the display of the terminal via connection to the server, the command executed via the input device is transmitted to the server, and the server transmits information data to be displayed on the display of the terminal to the terminal (S168-S174).

Further, the guidelines and display boxes (summary information) are displayed on the display.

Unless the selected phase is a phase for connection to another Internet site, information corresponding to the phase manipulation command is displayed on the display (S176-S178). However, if a phase, selected after the manipulation command, is a phase for connection to another Internet site, the information of the connected Internet site is displayed on the display. Further, various functions are performed in the connected site (S180-S182).

Performing various functions in the connected Internet site means performing all functions that are actually available over the Internet. For example, the terminal may also be connected to a typical payment system for selecting a product and paying for the product. That is, the terminal may be connected to a desired Internet site and perform a required task.

Further, the functions may be terminated in compliance with a termination command (184).

### Embodiment 6

FIG. 17 is a diagram showing another embodiment of a phased input method.

FIG. 17(A) illustrates an embodiment in which guidelines 50 and 51 on which scales 50a, 50b, 50c, 50d, and 50e are indicated may be displayed on the screen of the display 30. Further, distance “L” corresponding to an interval between scales indicated on the display 30 (distance actually displayed on the display) may be actually identical to the movement distance at which a point is moved upon executing a phase manipulation command.

For example, when the distance “L” actually displayed on the display is 10 mm, a movement distance corresponding to phase 1 in which the point is moved via the input device in compliance with the phase manipulation command is 10 mm. Therefore, the user who executes the corresponding phase manipulation command may display information in a desired phase on the display by moving a distance corresponding to the actual size of the scales on the guidelines 50 and 51 displayed on the display (moving via the input device).

Further, FIG. 17B shows that forms in which phases 50a, 50b, 50c, 50d, and 50e are displayed on the display 30 may differ. Any forms or shapes may be applied to the embodiment of the present invention as long as they enable individual phases to be distinguished from each other.

In this case, upon executing each manipulation command, it is possible to execute the command by moving a distance corresponding to the phase via the input device, but it is also possible to execute the phase manipulation command by selecting a desired phase from among the phases displayed on the display. That is, in FIG. 17 (B), when a current state is phase 1 50a, and it is desired to display information corresponding to phase 5 on the screen, a display bar 55 corresponding to phase 5 50e needs only to be selected.

Meanwhile, FIG. 17 (C) illustrates an embodiment in which phases are displayed in other forms. Respective phases 50a, 50b, 50c, 50d, and 50e are displayed in the shape of boxes.

Therefore, forms in which the phases are displayed are not necessarily limited to the forms of the embodiments of the present invention. It is apparent that phases may be displayed in various forms.

### Embodiment 7

FIGS. 18 to 23 are diagrams showing embodiments in which the size of a selection area is changed according to the phase.

FIG. 18 is a diagram showing that, as the phase increases, an original selection area 32 changes to a size-changed selection area 32a, and that, as the size of the selection area is larger, the amount of information to be displayed increases.

1) If the selection area 32 is magnified via the input device, a size-changed selection area 32a is displayed.

2) The size of the selection area may increase in phases, wherein the amount of information displayed in the selection area further increases as the size becomes larger.

Of course, additional information may be displayed without increasing the size of the selection area, depending on the circumstances.

3) The size of the selection area 32 may be reduced in phases via the input device, wherein the amount of information displayed in the selection area is reduced.

Of course, additional information may be displayed without increasing the size of the selection area, depending on the circumstances.

4) When a point is moved in a positive (+) direction in phase 1, phase 2 or 3 is selected, and the size of the selection area increases in phases, and then information corresponding to each phase is displayed on the screen of the display.

For example, when phase 2 is 1 cm larger than phase 1, a command for selecting the selection area and increasing the size of the selection area by 1 cm may be executed via the input device. Then, on the screen of the display, the size of the selection area is increased by 1 cm, and, as a result, phase 2 is displayed. Further, the selection area 32 becomes a selection area 32a, the phase of which has changed, thus enabling the amount of information displayed in the selection area 32a to change or vary.

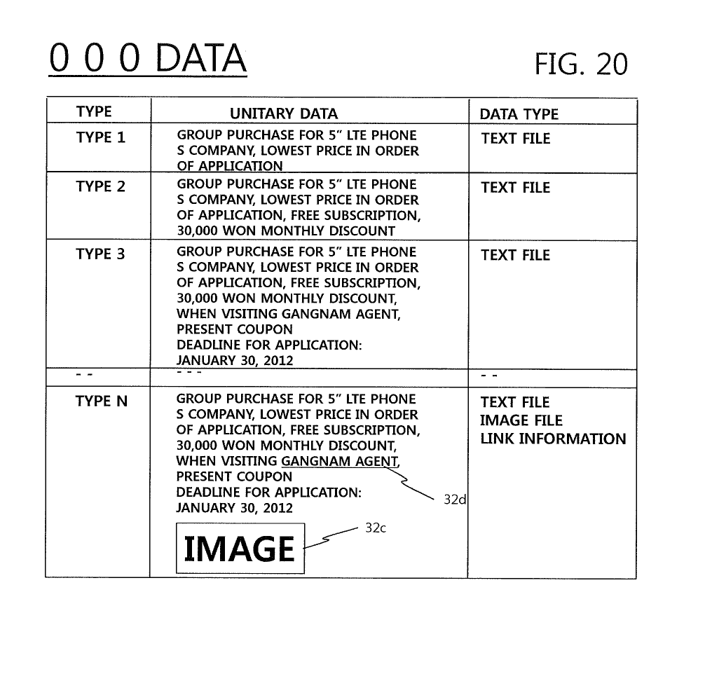

FIG. 19 is a diagram showing an embodiment in which information, such as an image, may be displayed as the selection area becomes larger. Further, in FIG. 19, although phases are represented by three phases for convenience of description, it is apparent that the phases may be further subdivided.

Further, a selection area 32a, the size of which has changed from the original selection area 32, may vertically increase and also horizontally increase in size.

FIG. 20 is a diagram showing an embodiment in which information is stored. That is, when the phase of the size is divided into N phases, pieces of information corresponding to the respective phases are stored. At this time, respective types correspond to respective phases, wherein if a relevant phase is selected, information suitable for the selected phase is displayed on the display.

Further, the information is stored in the memory unit 21 of the terminal or the DB 104 of the server. Of course, the information may also be stored in a separate storage device or a separate server.

Further, as the displayed information, not only a text file but also an image file 32c or a video file may be present.

Further, when a specific portion (‘Gangnam agent’ in FIG. 20) 32d of information displayed in any phase is clicked, connection to an additional site may be made. For this, information displayed on the display and information about a link to the additional site must be stored in type N (phase N).

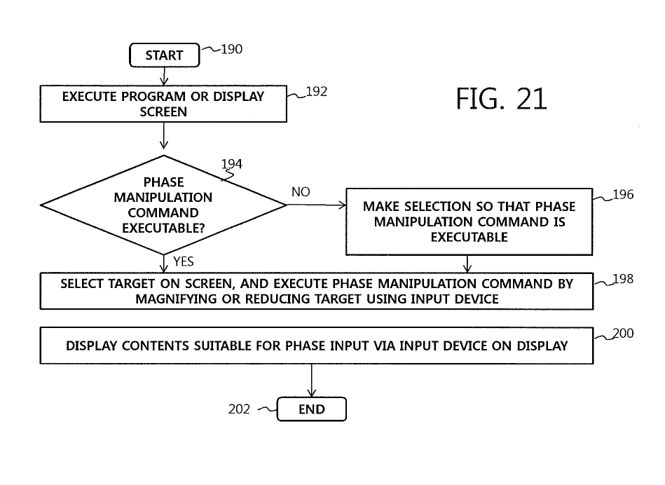

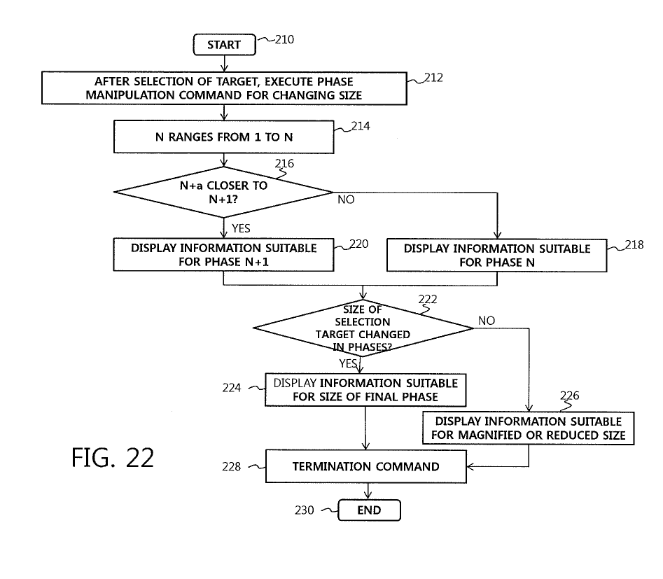

FIGS. 21 and 22 are flowcharts.

A program is executed and a screen is displayed (S190-S912).

Further, if a phase manipulation command is not executable, a selection must be made such that the phase manipulation command is executable (S194-S196).

When the terminal is prepared to execute a phase manipulation command, if a selection area 32 is selected from the screen, and then a phase manipulation command is executed via the input device 28, size-changed selection areas 32a and 32a′ and pieces of information suitable for the areas are displayed on the screen of the display (S198-S200). Further, the process may be terminated in response to a termination command (S202).

FIG. 22 is a diagram showing an embodiment in which a phase manipulation command is smoothly executed.

After the execution of a program or the display of the screen has started, the selection area 32 is selected, and a manipulation command for changing a size is executed (S210-S212).

Further, types may be assumed to range from type 1 to type N, and the size of the selection area 32 is designated to be appropriate for each of types 1 to N (214). Such designated sizes are stored in the memory unit 21 or the DB 104.

Further, an issuer who issues a phase manipulation command may precisely adjust the size of the selection area 32 to the designated size suitable for each type, but, in reality, there are many cases where the size of the selection area cannot be precisely adjusted.

In this case, the size adjusted by the manipulation command issuer may be N+a. Here, is the value of N+a is a value between sizes in type N and type N+1.

At this time, when the final size N+a of the selection area 32a executed by the phased manipulation command issuer is closer to N+1 type, the selection area 32a is displayed on the display at the size of N+1 type, and information is also displayed as N+1 type information (S216, S220).

In contrast, when the final size N+a of the selection area 32a executed by the phase manipulation command issuer is closer to N type, the selection area 32a is displayed on the display at the size of N type and information is displayed as N type information (S216-S218).

Meanwhile, when the size of the selection area is not changed in phases, the selection area 32a or 32a′ is displayed on the display 30 at the size corresponding to the result of the phase manipulation command by an operator. However, when the size of the selection area is changed in phases, the selection area 32a is displayed on the display 30 at the size displayed at steps S218 and S220. Further, the process is terminated in compliance with a termination command.

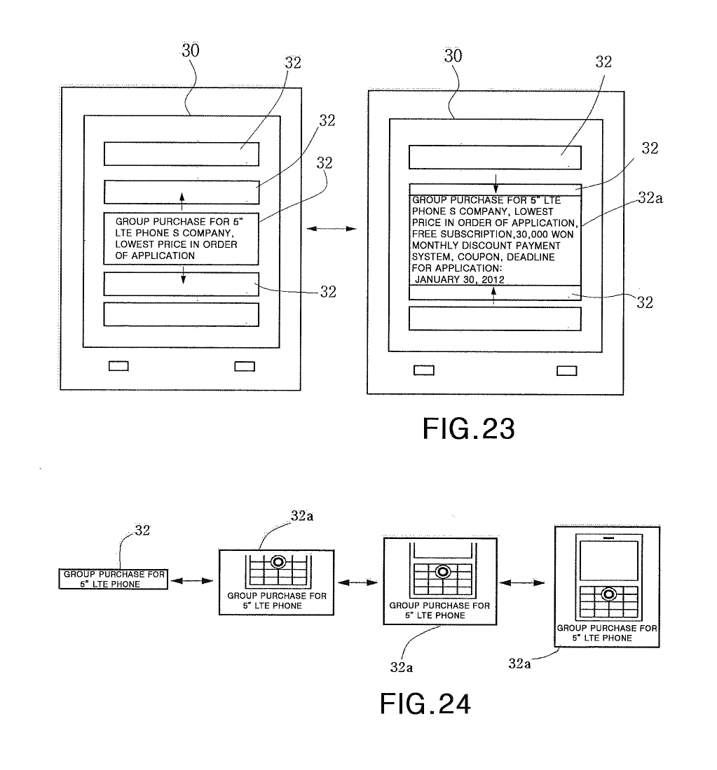

FIG. 23 is a diagram showing a further embodiment, in which two or more selection areas 32, each enabling a phase manipulation command to be executed, may be displayed on the display. Further, one of the selection areas 32 may be selected and then a phase manipulation command may be executed in the selected area.

### Embodiment 8

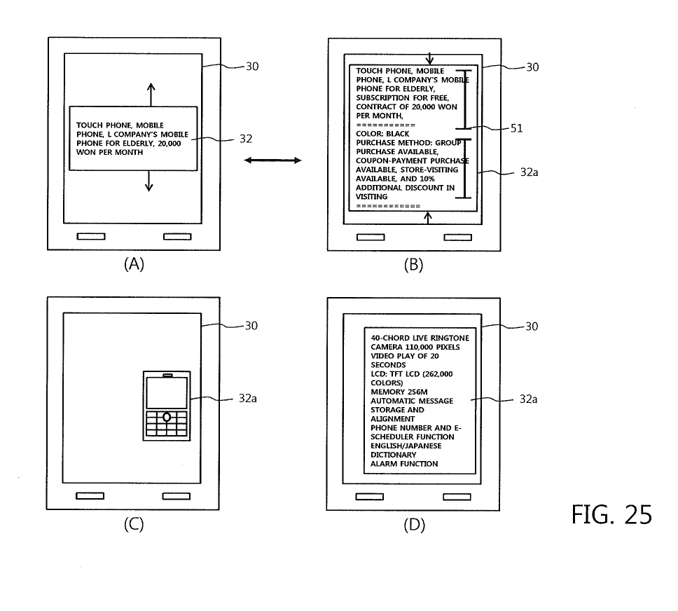

FIGS. 24 and 25 are diagrams showing embodiments in which the content and size of information are variously changed.

As in the example of FIG. 24, when information to be displayed is an image, the information may be displayed to suit the size of a size-changed selection area 32 in compliance with a phase manipulation command.

FIG. 25 is a diagram showing a form in which the size of the selection area is changed in phase 1 and phase 2 and in which the size of the selection area is not changed in phase 3 and phase 4. That is, both phases causing the size to be changed and phases causing the size to be unchanged may be used.

### Embodiment 9

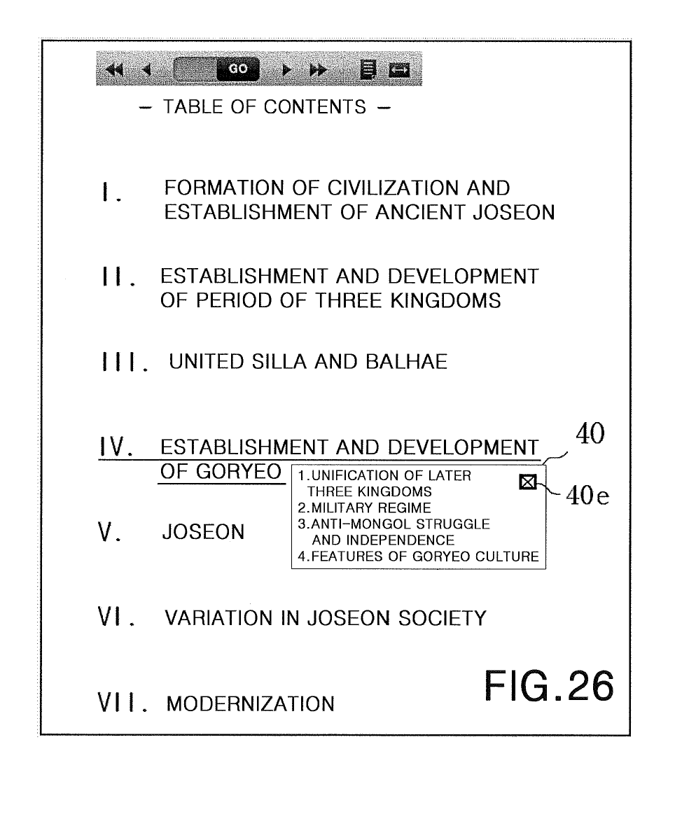

FIGS. 26 to 28 are diagrams showing another embodiment of the case where a selection area is present in the entire screen.

Further, one, or two or more selection areas may be present.

FIG. 26 is a diagram showing an embodiment of a table of contents.

In an upper portion of a display, menu items are displayed. Further, a phase manipulation command may be executed on a table of contents ranging from item I to item VII. Therefore, when one item is selected from the table of contents and a phase manipulation command is executed on the item, information suitable for the results of execution is displayed on the screen of the display.

In this regard, a separate window 40 may be displayed and the results of the phase manipulation command may be displayed therein. That is, when one item is selected from the table of contents and is activated (a method of distinguishing the selected item from other items in such a way as to change the color of text “Establishment and development of Goryeo” may be selected), the corresponding phase manipulation command is executed.

Further, the activation of the selected item means that the CPU of the terminal (or the control unit of the server) is prepared to recognize a phase manipulation command.

Furthermore, a function of closing a display window may be added. As shown in FIG. 26, the display window may be immediately closed by selecting “x” mark 40e. That is, when the “x” mark 40e is selected, the display window is closed or switched to an initial display phase (phase 1 or 0).

By using this method, the phase manipulation command may be implemented in a hierarchical structure. A phase manipulation command may be executed in the selection area of “Establishment and development of Goryeo”, so that a list of items, such as “1. Unification of the later three kingdoms”, and “2. Military regime” displayed in the separate window 40, may be a target of the phase manipulation command. That is, when item “4. Features of Goryeo culture” may be selected and a phase manipulation command is executed thereon, information in an additional phase related to “4. Features of Goryeo culture” is displayed.

Further, when one of items in the finally displayed list is selected, a page corresponding to the selected list item is displayed on the display.

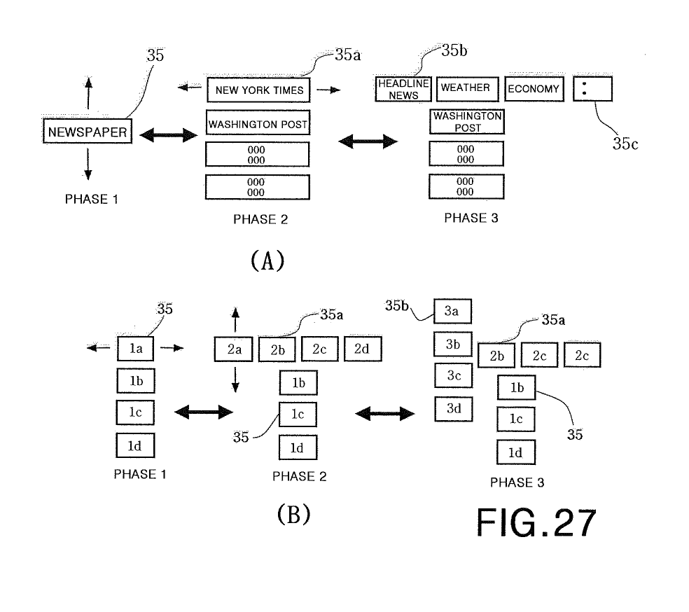

FIG. 27 is a diagram showing a further embodiment in which the selection area is changed in compliance with a phase manipulation command.

A single selection area 35 is present (of course, two or more selection areas may be present) on the screen displayed on the display 30. When one of the selection areas is set to a target and is moved in a positive (+) direction, additional information 35a having multiple selection areas appears.

Further, when one of the multiple selection areas present in the additional information 35a is selected to execute a phase control command in the selected area, and a current point is moved in a positive (+) direction, other additional information 35b horizontally appears. Further, when the current point is moved in a negative (−) direction, an original state is recovered.

Furthermore, more additional information 35a (or other additional information 35b) appears in proportion to a positive (+) movement distance.

That is, in compliance with a phased manipulation command, a new list is displayed, one item is selected from the new list, and then a phase manipulation command may be executed again.

For example, as shown in FIG. 27(A), when phase 1 35h is newspaper information, newspaper company information appears in phase 2 35a if a phase manipulation command is executed in phase 1. If one newspaper company is selected from the newspaper company information in phase 2 35a, and a phase manipulation command is executed on the selected information, news classification information corresponding to phase 3 35b is displayed. In this case, if weather or headline news, which is one of pieces of news classification information, is selected, the selected information is displayed on the display screen or is connected to an Internet site in which the selected information is displayed. Meanwhile, one item of the list displayed in phase 3 may be a search box 35c and then a function of entering a keyword into the search box 35c and searching for data matching the keyword may be assigned.

On the same principle, Internet information may be displayed in phase 1 35, Yahoo and Google may be displayed in phase 2, and connection to the detailed information of an Internet portal site may be made in phase 3.

Further, as shown in FIG. 27 (B), a phase manipulation command may be executed. That is, when there are several items corresponding to phase 1 35, and one of the items in phase 1 35 is selected to execute a phase manipulation command thereon, selected phase 1 is displayed as phase 2 35a. Further, when one of items in phase 2 is selected to execute a phase manipulation command thereon, the selected phase 2 is displayed as phase 3 35b.

Further, in the example of FIG. 27, each list may be, but is not limited to, the Internet information or newspaper information, but may be information having various hierarchical structures.

Further, the list is not necessarily limited to the display of information. A control command button may also be displayed in the same manner. When there are more than hundreds of thousands of control command buttons and then it is difficult to display the buttons at one time, the control command buttons may be divided into phases and may be displayed in the form of phased manipulation commands. Therefore, if one item is selected from the list displayed in the final phase (phase 3 in (B)), the selected control command is executed.

Such a procedure is performed by the CPU selecting information stored in the memory unit. Further, an algorithm enabling such a procedure to be executed is also stored in the memory unit. For this, information stored in each phase is stored in the memory unit 21.

Further, when the control unit of the server performs the procedure, information corresponding to each phase is stored in the DB 104 of the server and an executable algorithm is also stored in the DB.

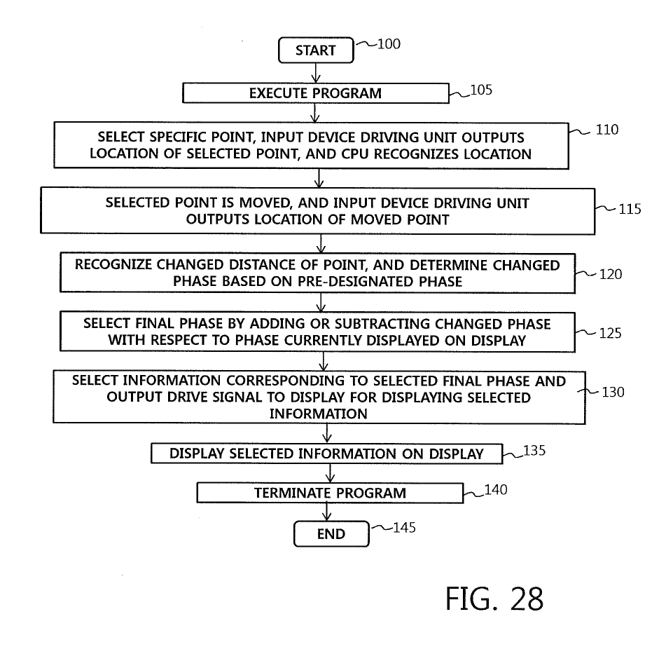

FIG. 28 is a flowchart showing an embodiment in which the server transmits information connected to each phase.

When the terminal is started, and a program is executed to access the server, the control unit 101 of the server 100 selects information to be displayed on the display 30 of the terminal 110 from the DB 104, and transmits the selected information to the terminal over a wired/wireless communication network (or the Internet).

Further, when the CPU 20 of the terminal outputs a display drive signal based on the received information, the display 30 consequently displays the information received from the server (S250-S265).

In this case, it is determined whether a phase control command is executable on the entire screen displayed on the display. Further, it is determined whether a selection area is present on the screen of the display and a phase control command is executable in the selection area. That is, if it is determined that the phase control command is executable on the display screen, the server transmits information in another phase, associated with the information displayed on the display screen, to the terminal (S270-S275).

That is, referring to the example of FIG. 20, when the information of type 1 (phase 1) is displayed on the terminal display, the server also transmits pieces of information ranging from type 2 (phase 2) to type N (phase N) together with type 1 information to the terminal.

The CPU 20 of the terminal stores the received information in the memory unit 21. When a phase manipulation command is executed via the input device 28, the CPU 20 determines a final phase according to an embodiment of the present invention, selects information corresponding to the final phase, and displays the selected information on the display.

That is, the CPU 20 of the terminal selects information corresponding to the final phase from among pieces of information ranging from phase 2 to phase N, received from the server, and displays the selected information on the display.

(S180) Meanwhile, when the program is terminated and a termination switch is operated, the performance of the terminal is terminated (S285-8290).

### Embodiment 10

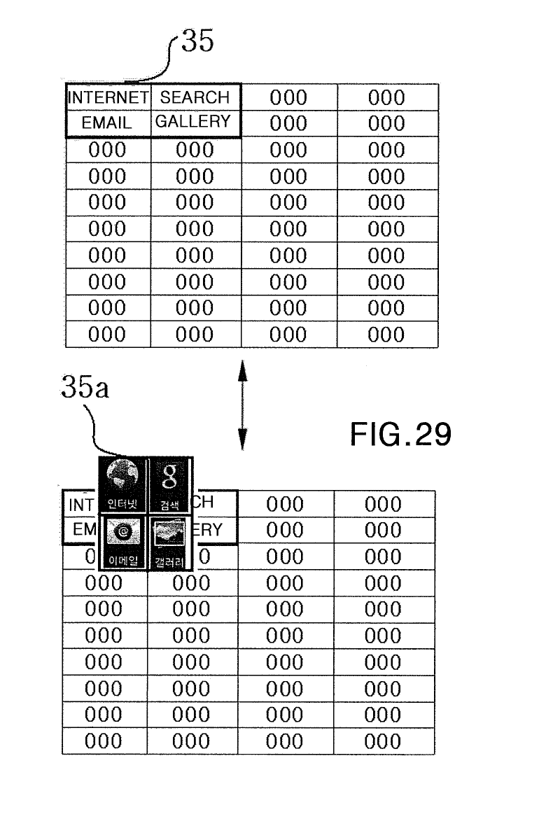

FIG. 29 is a diagram showing another embodiment of the present invention.

This drawing shows an embodiment in which a phase manipulation command according to the present invention is applied to the icons of a smart phone. When there are several icons, it is difficult to completely display all icons on a single screen. In this case, when a single table is generated using small letters, more icons may be displayed on a single screen.

However, when a table is generated using small letters, such a small letter cannot be selected by the hand. In this case, in order to solve this problem, when part of the table becomes phase 1 35 of the selection area, and a phase manipulation command is executed in the selection area, only the selection area is magnified and becomes phase 2. Further, since an icon image appears in the area 35a of phase 2, the icon image magnified to have a size of some degree may be selected using the finger.

Further, in FIG. 29, the upper left portion of the table is set to the selection area, but any location in the table may be set to the selection area.

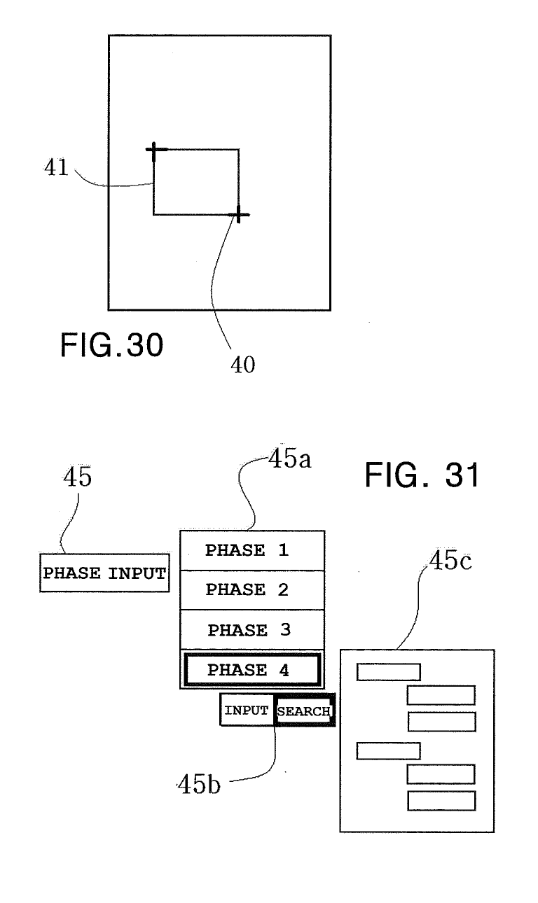

FIG. 30 is a diagram showing an embodiment in which a selection area enabling phase manipulation commands to be executed may be designated.

As shown in the drawing, when two points capable of defining a rectangle are selected and a selective line 40 is generated, a rectangle including the selective line is formed, and the formed rectangle becomes a line area 40. That is, the formed rectangular area is a selection area 41 and becomes phase 1 (or phase N that is the highest phase). Then, by the information storage method shown in FIG. 20, image or data information corresponding to the selection area 41 is stored at the storage location in phase 1.

Further, a phase manipulation command may be executed in the newly designated selection area 41.

FIG. 31 is a diagram showing an embodiment of a method of storing information in phases.

When phase input 45 is selected on the display screen, individual phases, such as phase 1 and phase 2, are displayed in the form of a list. Meanwhile, in FIG. 30, the selection of phase input 45 means the operation of allowing the user of the present invention to designate the selection area 35 (or the entire screen), thus preparing for the performance of phased information input. Further, if the phased information input has been completed, a phase manipulation command may be executed.

In any case, one item may be selected from a phase list 45a displayed in the phase input 45. In FIG. 30, an embodiment in which phase 4 is selected from the phase list 45a is depicted. That is, when phase 4 is selected, an information input method 45b is displayed. Further, in the information input method 45b, phase 4 is divided into “input” enabling information to be directly entered and “search” enabling a file to be searched for and information to be attached.

Further, when “input” is selected, an input window (not shown) enabling information to be entered is displayed. When “search” is selected, a directory is displayed so that information may be searched for in the memory (or DB).

That is, the user of the present invention may input information in correspondence with phase 1, phase 2, phase 3, or phase N. When information is input in this way, the information is to stored using the method shown in the embodiment of FIG. 20.

For example, information of a single set “K10001” having several phases is present, and phase 1 information may be “K10001-01”, phase 2 information may be “K10001-02”, or phase N information may be “K10001-N”.

In this case, when the information of the single set “K10001” is sent via a text message or email, pieces of information in respective phases included in “K10001” are also transmitted. Further, a user who receives the information displays the pieces of information in respective phases on the display by executing the phase manipulation command on the information “K10001”.

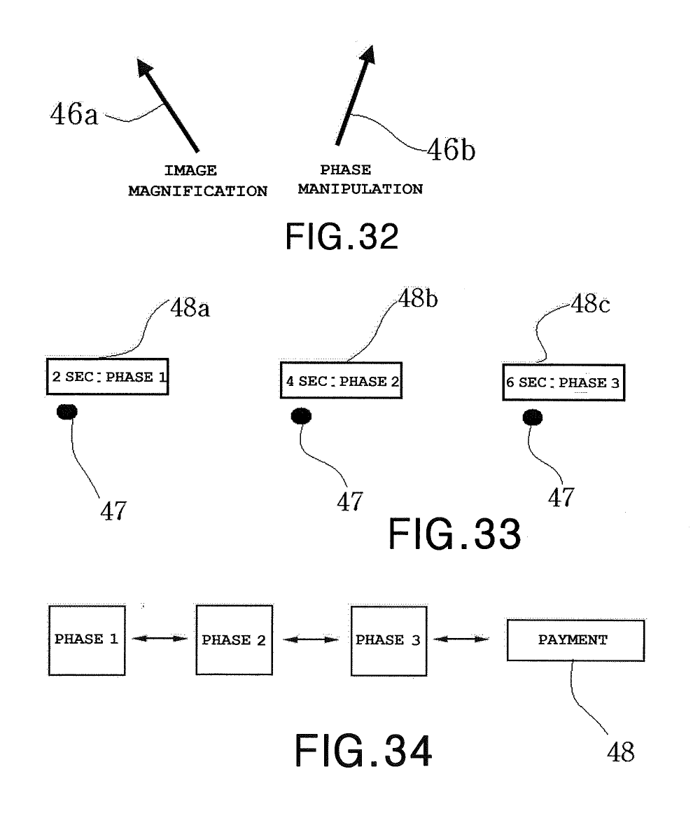

FIG. 32 is a diagram showing an embodiment in which an image magnification function and a phased manipulation command function are distinguished from each other.

A conventional touch manipulation method that is typically used is a method of magnifying an image. However, the present invention relates to a phase manipulation command. Further, any area (or the entire area) displayed on the screen of the display 30 enables both an image magnification function and a phase manipulation command function to be performed.

That is, when an area enabling the two functions to be performed is selected, an arrow 46a for image magnification and an arrow 46b for a phase manipulation command may be displayed on the screen of the display. At this time, when it is desired to magnify an image, a touch input is performed in the direction of the arrow 46a on which image magnification is indicated. When it is desired to execute a phase manipulation command, a touch input needs to be performed in the direction of the arrow 46b on which a phase manipulation command is indicated.

That is, a single embodiment is depicted in which both image magnification and a phase manipulation command may be selected on the screen of the display and in which the guidance of a touch input method is indicated. Further, the indication of the above-described input method guidance may be implemented using various methods. This merely shows an example in which an area enabling both the image magnification function and the phase manipulation command function to be performed may be present in the present invention.

FIG. 33 is a diagram showing an embodiment in which a phase manipulation command is executable according to a selected time.

On the screen of the display, when a selection area 35 (or the entire display screen) is selected on the display screen, a selected point 47 is designated. Further, phases are classified according to the length of a time during which the point 47 is selected.

For example, 2 seconds may be set to phase 1, and 4 seconds may be set to phase 2. Further, an indication that the phase is changed according to the selected time may be displayed via phase information 48a. That is, when 6 seconds is selected, an indication that phase 3 has been reached is displayed via phase information 48a.

FIG. 34 is a diagram showing an embodiment in which a new function may be assigned to a phase manipulation command.

When a manipulation command in phase 1, a manipulation command in phase 2, and a manipulation command in phase 3 are executed, pieces of information corresponding to the respective phases are displayed on the screen of the display. However, when a manipulation command in phase 4 is executed, a message requiring “payment” may be displayed without information corresponding to phase 4 being displayed on the screen of the display. That is, a message indicating a new task may be included in the phases of phase manipulation commands. Of course, when a payment is selected, a payment function is performed.

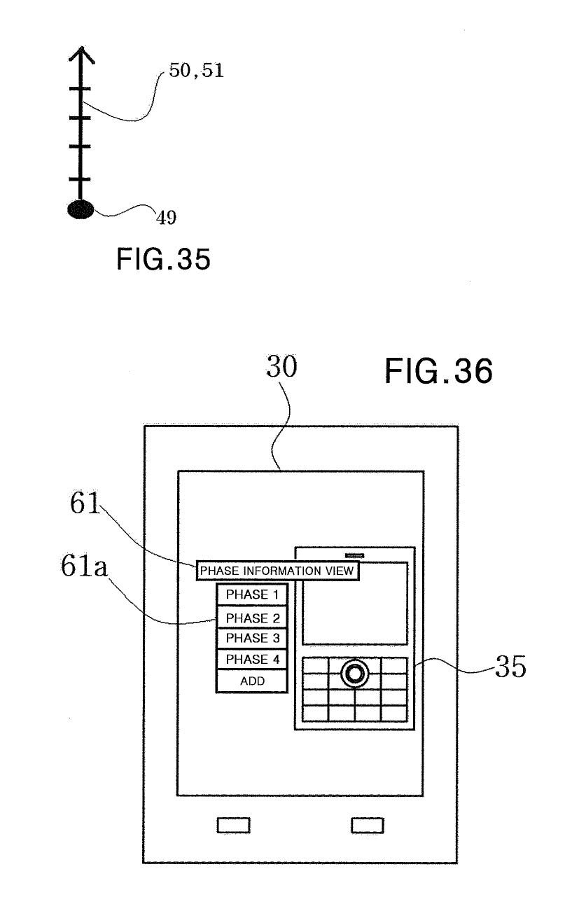

FIG. 35 is a diagram showing an embodiment of a method of displaying a guideline.

A guideline starts at point 49 selected by a user who executes a phase manipulation command. That is, when the location information of the point at which a phase manipulation command is to be executed is input (corresponding to a point selection procedure), a guideline is indicated while using the location of the point as a starting point.

FIG. 36 is a diagram showing an embodiment in which a phase may be added.

As shown in the drawing, when phase information view 61 is selected, items of a phase list 61a are listed. When one phase (e.g., phase 2) is selected from the phase list, the selected information (e.g. phase 2) is displayed on the screen of the display, thus enabling information in a desired phase to be checked.

However, when “addition” is selected from the phase list 61a, a new additional phase may be generated, and a new phase may be generated by inputting information to the additional phase or by selecting and storing an information file. In this way, as in the case of the embodiment of FIG. 31, new additional phase information is also stored in a single information set.

At this time, the additional phase may be generated between previously present phases (e.g., an additional phase may be generated between phase 2 and phase 3 and then previous phase 3 becomes phase 4), and may be generated using a method of adding a phase after a final phase (e.g., if there are five phases, phase 6 may be added).

### Embodiment 11

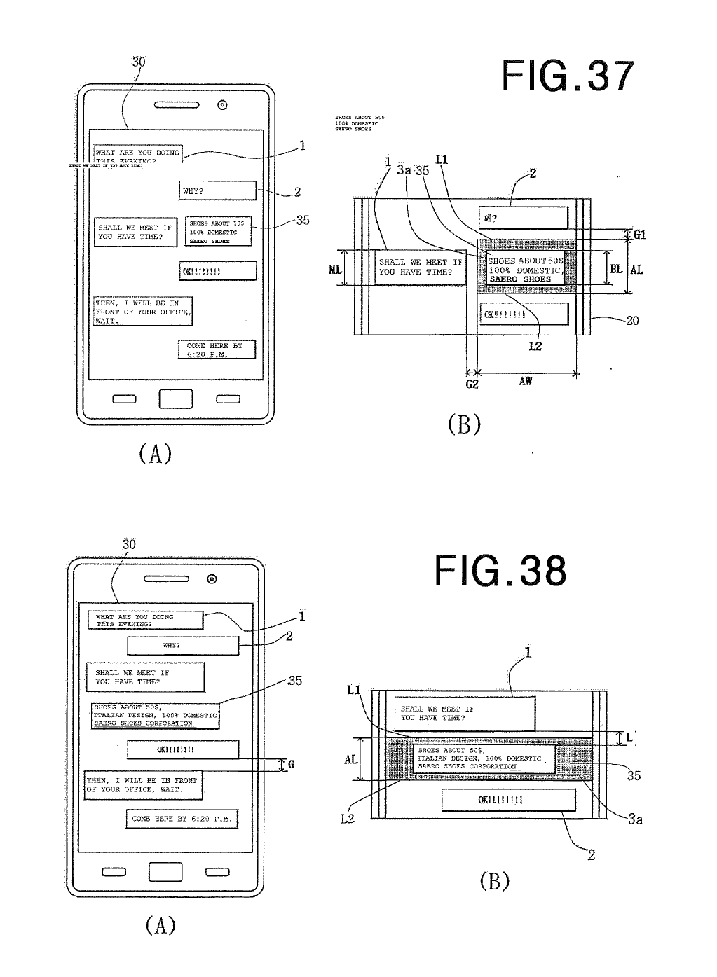

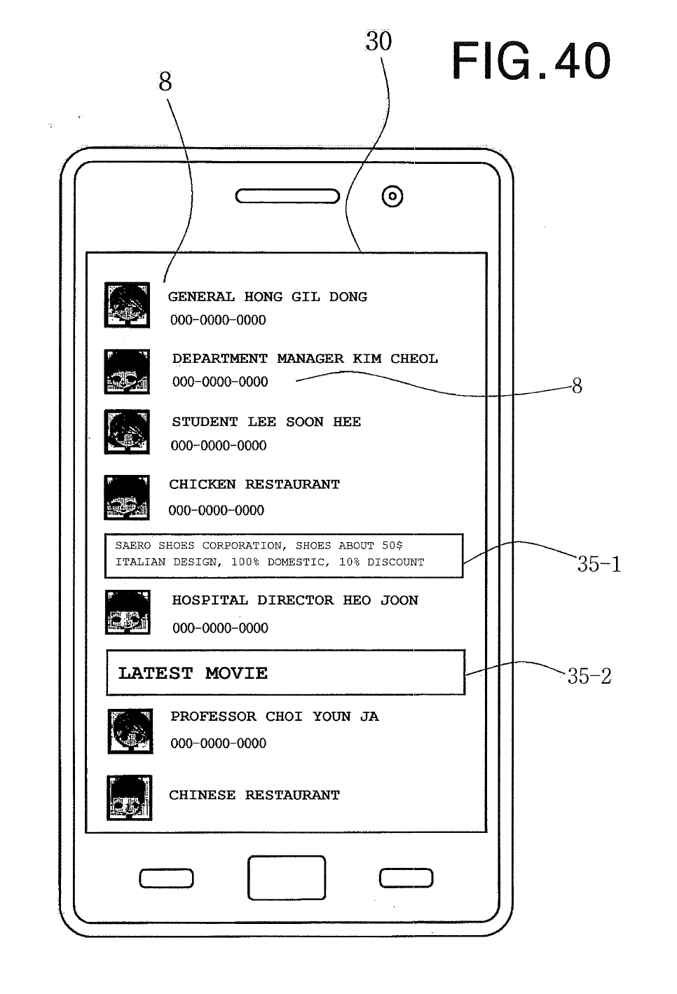

FIGS. 37 to 40 are diagrams showing embodiments in which a selection area is present in a text message service.

That is, a selection area 35 is present in a text message service, and a phase manipulation command may be executed in the selection area 35.

Referring to FIG. 37(A), the selection area 35 is located besides a received message box 1 (of course, according to the circumstances, the selection area 35 may be located as an advertising box besides a sent message box 2).

Of course, as shown in FIG. 37(B), an advertising box area 3a is present, and a selection area 35 is present as an advertising box in the advertising box area. Further, the length “AL” of the advertising area (or the length “BL” of the selection area 35) may be changed according to the length “ML” of the message box 1 or 2. That is, as the length of the message box 1 or 2 is increased or decreased, the length of the advertising area 3a may also be increased or decreased.

Further, it is better that the distance G1 between the advertising box area 3a and the message box does not exceed 4 mm.

Referring to FIG. 38 (A), an embodiment is illustrated in which an advertisement is displayed as the selection area 35 between messages 1 and 2 that are sent or received. At this time, there is no need to always set the size of each advertising area 3a to the same size. It means that, depending on the situations, the length “AL” of the advertising area 3a may be increased or decreased. Further, the size of the advertising area 3a may be identical to that of the selection area 35, but it is visually attractive when the size of the selection area 35 is smaller than that of the advertising area 3a. Even if the size of the selection area 35 is less than that of the advertising area 3a, it is preferable that the size of the selection area 35 be equal to or greater than ½ of the size of the advertising area 3a. The reason for this is to effectively use a message screen.

A relationship between “L” and “G” indicated in the drawing is given as follows. That is, “L” is equal to or greater than “½G” and is less than or equal to “2G”.

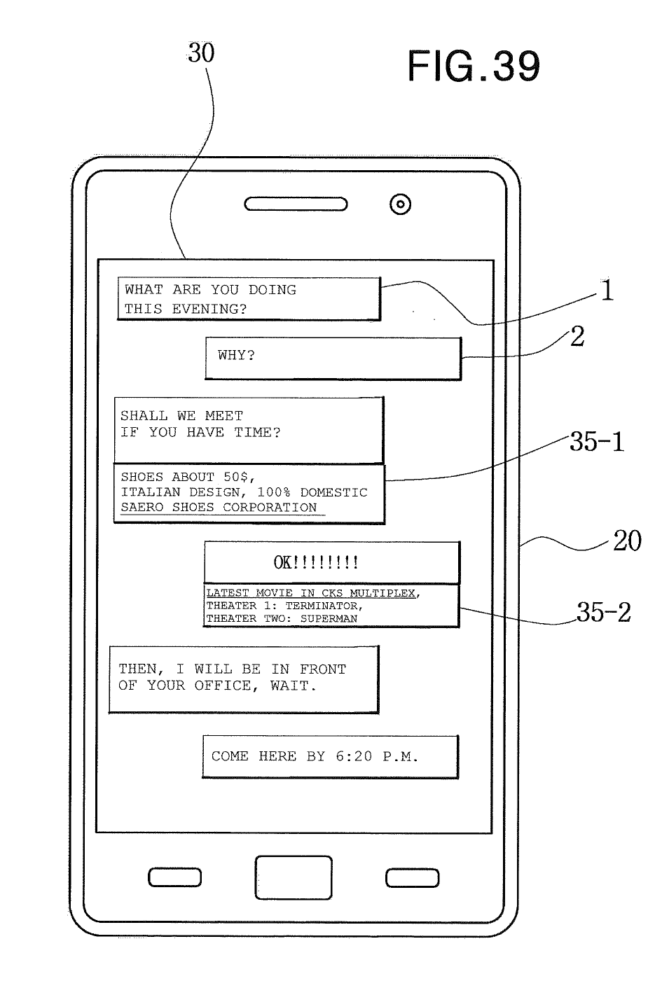

FIG. 39 is a diagram showing an embodiment in which sent or received message boxes 1 and 2 and selection areas 35 as advertising boxes are adjacent to each other.

In this case, it is natural that selection areas 35 are attached to the top or bottom of the message boxes 1 and 2, as shown in the drawing, but it is apparent that the selection areas and message boxes may be separated from each other in consideration of a design form.

FIG. 38 is a diagram showing an embodiment in which, when a list 5 of persons who exchange messages is displayed, selection areas 35-1 and 35-2 may be present in the middle of the list 5.

Here, in the selection areas, various types of information, such as newspaper or news in addition to advertisements, may be displayed. cl Embodiment 12

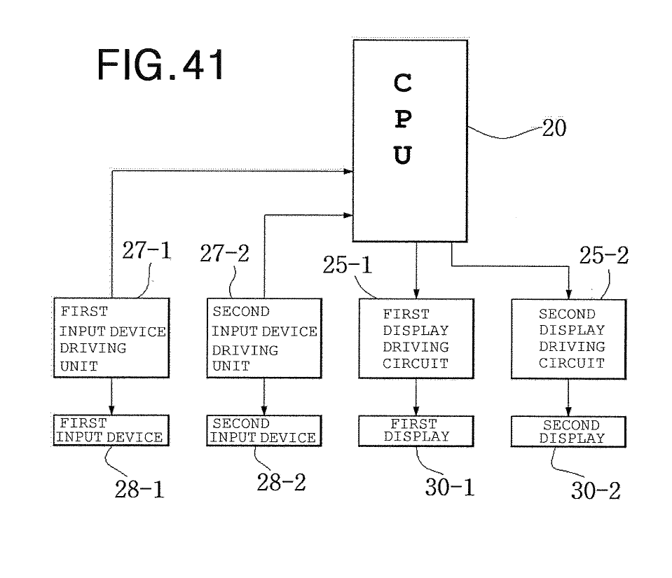

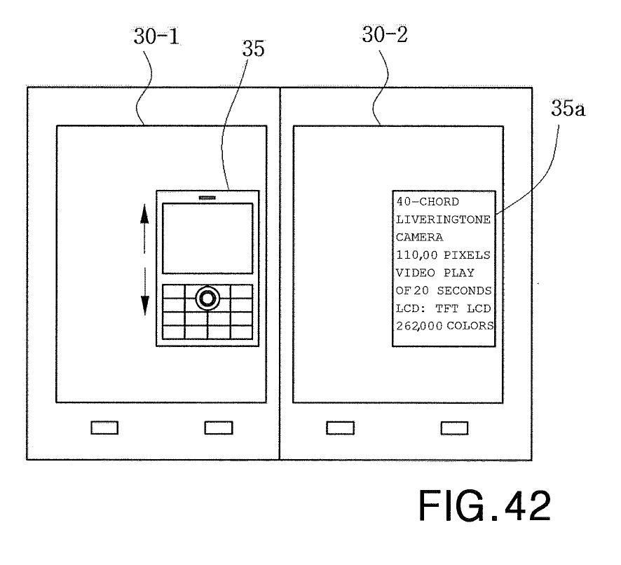

FIGS. 41 to 42 are diagrams showing embodiments of the case where two or more displays are provided.

As shown in FIG. 41, a first display 30-1 and a second display 30-1 are provided, and first and second display driving circuits 25-1 and 25-2 are also provided. Further, a first input device 28-1 is provided in the first display, and a second input device 28-2 is provided in the second display. Furthermore, first and second input device driving units 27-1 and 27-2 for driving the input devices are provided.

In this case, the two displays 30-1 and 30-1 and the two input devices 28-1 and 28-2 are controlled by a single CPU 20.

FIG. 42 is a diagram showing an embodiment in which phase manipulation commands are displayed on two displays. That is, when a phase manipulation command is executed on a first display 30-1, the results of the execution are displayed on the second display 30-2. Of course, when a phase manipulation command is executed on the second display, the results of the execution may be displayed on the first display.

For example, when a selection area (current phase 1) is selected on the first display 30-1 and is moved by two phases in compliance with a phase manipulation command, the final phase is phase 3, and information corresponding to phase 3 is displayed on the second display 30-2.

The function of FIG. 42 may be executed on the CPU of the terminal (or the control unit of the server) by an algorithm stored in the memory unit of the terminal (or the DB of the server). That is, information corresponding to a final phase, selected as a result of executing a phase manipulation command input via the first input device 28-1 provided in the first display, is displayed on the second display.

### MODE FOR INVENTION

### Industrial Applicability

According to the present invention, when a phase manipulation command is executed with a finger or a manipulation means via an input device on a display, information may be provided in phases. In addition, when multi-phase information is provided, it may be displayed on the same screen without changing the screen, and a link to information stored in another Internet website or another storage location may be performed.

1. A phased information provision system and method, wherein:
a terminal provided with a display, a Central Processing Unit (CPU), and an input device is configured such that, when a phase manipulation command for distinguishing individual phases is input on the display, the input device outputs the phase manipulation command, and the CPU recognizes a phase of the phase manipulation command and outputs information suitable for the phase to the display.

2. The phased information provision system and method of claim 1, wherein the CPU is configured to, when a point on the display is selected, and the point is moved and then information about a movement distance of the point is output, determine the movement distance to be a phase.

3. The phased information provision system and method of claim 1, wherein the CPU is configured to, when a point on the display is selected, and the point is rotated and then information about a rotational direction of the point is output, determine an angle of a rotational motion of the point to be a phase.

4. The phased information provision system and method of claim 1, wherein the phase includes a positive (+) movement phase.

5. The phased information provision system and method of claim 1, wherein the phase includes a negative (−) movement phase.

6. The phased information provision system and method of claim 1, wherein the phase is designated, as two points are selected via the input device and a distance between the two points is shortened or lengthened.

7. A phased information provision system and method, wherein:
a terminal provided with a display, a Central Processing Unit (CPU), and an input device is connected to a server provided with a database (DB) and a control unit,
when a phase manipulation command for distinguishing individual phases is input on the display, the input device outputs the phase manipulation command, and the CPU recognizes a phase of the phase manipulation command,
the CPU transmits information about determination of the phase of the phase manipulation command to the server, or transmits a phased manipulation command signal from the input device to the server, and
the server outputs information about the phase from the DB and transmits the information to the terminal.

8. The phased information provision system and method of claim 1, wherein the CPU is configured to, when a point on the display is selected, and the point is moved and then information about a movement distance of the point is output, determine the movement distance to be a phase.

9. The phased information provision system and method of claim 1, wherein the CPU is configured to, when a point on the display is selected, and the point is rotated and then information about a rotational direction of the point is output, determine an angle of a rotational motion of the point to be a phase.

10. The phased information provision system and method of claim 1, wherein the phase includes a positive (+) movement phase.

11. The phased information provision system and method of claim 1, wherein the phase includes a negative (−) movement phase.

12. The phased information provision system and method of claim 1, wherein the phase is designated, as two points are selected via the input device and a distance between the two points is shortened or lengthened.

13. The phased information provision system and method of claim 1, wherein when a current phase is phase N and is moved in a positive (+) direction by J phases, a finally selected phase is phase N+J.

14. The phased information provision system and method of claim 1, wherein when a current phase is phase N and is moved in a negative (−) direction by I phases, a finally selected phase is phase N−I.
